(19) United States
(12) Patent Application Publication
(10) Pub. No.: US 2024/0430430 A1
(43) Pub. Date: Dec. 26, 2024

(54) METHOD, APPARATUS, AND MEDIUM FOR VISUAL DATA PROCESSING

(71) Applicants: Beijing Bytedance Network Technology Co., Ltd., Beijing (CN); Bytedance Inc., Los Angeles, CA (US)

(72) Inventors: Semih ESENLIK, Los Angeles, CA (US); Zhaobin ZHANG, Los Angeles, CA (US); Yaojun WU, Beijing (CN); Kai ZHANG, Los Angeles, CA (US); Yue LI, Los Angeles, CA (US); Li ZHANG, Los Angeles, CA (US)

(21) Appl. No.: 18/823,515

(22) Filed: Sep. 3, 2024

Related U.S. Application Data
(63) Continuation of application No. PCT/CN2023/079546, filed on Mar. 3, 2023.

(30) Foreign Application Priority Data
Mar. 3, 2022 (WO) PCT/CN2022/079005

(51) Int. Cl. H04N 19/132; H04N 19/124

(52) U.S. Cl. CPC H04N 19/132; H04N 19/124

(57) ABSTRACT

Embodiments of the present disclosure provide a solution for visual data processing. A method for visual data processing is proposed. The method comprises: obtaining, for a conversion between visual data and a bitstream of the visual data, statistical information associated with a first representation of the visual data, the first representation being generated based on applying a first neural network to the visual data; determining at least one sample from a second representation of the visual data based on the statistical information, a value of the at least one sample being absent from the bitstream, the second representation being obtained by quantizing the first representation; and performing the conversion based on the determining.

### CROSS REFERENCE

This application is a continuation of International Application No. PCT/CN2023/079546, filed on Mar. 3, 2023, which claims priority to Chinese Application No. PCT/CN2022/079005 filed on Mar. 3, 2022. The entire contents of these applications are hereby incorporated by reference in their entireties.

### FIELDS

Embodiments of the present disclosure relates generally to visual data processing techniques, and more particularly, to neural network-based visual data coding.

### BACKGROUND

The past decade has witnessed the rapid development of deep learning in a variety of areas, especially in computer vision and image processing. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable rate-distortion (R-D) performance with Versatile Video Coding (VVC). With the performance of neural image compression continually being improved, neural network-based video compression has become an actively developing research area. However, coding efficiency of neural network-based visual data coding is generally expected to be further improved.

### SUMMARY

Embodiments of the present disclosure provide a solution for visual data processing.

In a first aspect, a method for visual data processing is proposed. The method comprises: obtaining, for a conversion between visual data and a bitstream of the visual data, statistical information associated with a first representation of the visual data, the first representation being generated based on applying a first neural network to the visual data; determining at least one sample from a second representation of the visual data based on the statistical information, a value of the at least one sample being absent from the bitstream, the second representation being obtained by quantizing the first representation; and performing the conversion based on the determining.

According to the method in accordance with the first aspect of the present disclosure, a value of at least one sample of a quantization of the representation of the visual data is not comprised in the bitstream. Thereby, the proposed method makes it possible to skip at least a part of the quantization during the entropy coding process, so as to reduce the time spent for entropy coding. As such, the proposed method can advantageously improve the coding speed and the coding efficiency.

In a second aspect, an apparatus for visual data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of visual data which is generated by a method performed by an apparatus for visual data processing. The method comprises: obtaining, for a conversion between visual data and a bitstream of the visual data, statistical information associated with a first representation of the visual data, the first representation being generated based on applying a first neural network to the visual data; determining at least one sample from a second representation of the visual data based on the statistical information, a value of the at least one sample being absent from the bitstream, the second representation being obtained by quantizing the first representation; and generating the bitstream based on the determining.

In a fifth aspect, a method for storing a bitstream of visual data is proposed. The method comprises: obtaining, for a conversion between visual data and a bitstream of the visual data, statistical information associated with a first representation of the visual data, the first representation being generated based on applying a first neural network to the visual data; determining at least one sample from a second representation of the visual data based on the statistical information, a value of the at least one sample being absent from the bitstream, the second representation being obtained by quantizing the first representation; generating the bitstream based on the determining; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example visual data coding system, in accordance with some embodiments of the present disclosure;

FIG. 2 illustrates a typical transform coding scheme;

FIG. 3 illustrates an image from the Kodak dataset and different representations of the image;

FIG. 4 illustrates a network architecture of an autoencoder implementing the hyper-prior model;

FIG. 5 illustrates a block diagram of a combined model;

FIG. 6 illustrates an encoding process of the combined model;

FIG. 7 illustrates a decoding process of the combined model;

FIG. 8 illustrates two possible implementations of the entropy coding and quantization processes;

FIG. 9 illustrates corresponding decoder implementations for the encoder implementations;

FIG. 10 illustrates two possible implementations of the encoder in accordance with embodiments of the present disclosure;

FIG. 11 illustrates two possible implementations of the decoder in accordance with embodiments of the present disclosure;

FIG. 12 illustrates two possible probability distributions in accordance with embodiments of the present disclosure;

FIG. 13 illustrates an example visual data encoding process according to some embodiments of the present disclosure;

FIG. 14 illustrates an example visual data decoding process according to some embodiments of the present disclosure;

FIG. 15 illustrates a flowchart of a method for visual data processing in accordance with some embodiments of the present disclosure; and

FIG. 16 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

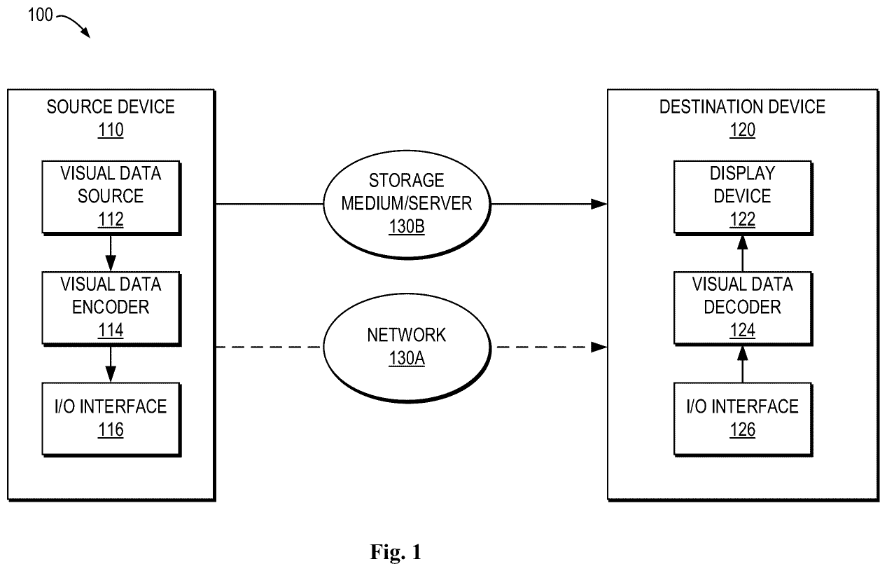

FIG. 1 is a block diagram that illustrates an example visual data coding system 100 that may utilize the techniques of this disclosure. As shown, the visual data coding system 100 may include a source device 110 and a destination device 120. The source device 110 can be also referred to as a visual data encoding device, and the destination device 120 can be also referred to as a visual data decoding device. In operation, the source device 110 can be configured to generate encoded visual data and the destination device 120 can be configured to decode the encoded visual data generated by the source device 110. The source device 110 may include a visual data source 112, a visual data encoder 114, and an input/output (I/O) interface 116.

The visual data source 112 may include a source such as a visual data capture device. Examples of the visual data capture device include, but are not limited to, an interface to receive visual data from a visual data provider, a computer graphics system for generating visual data, and/or a combination thereof.

The visual data may comprise one or more pictures of a video or one or more images. The visual data encoder 114 encodes the visual data from the visual data source 112 to generate a bitstream. The bitstream may include a sequence of bits that form a coded representation of the visual data. The bitstream may include coded pictures and associated visual data. The coded picture is a coded representation of a picture. The associated visual data may include sequence parameter sets, picture parameter sets, and other syntax structures. The I/O interface 116 may include a modulator/demodulator and/or a transmitter. The encoded visual data may be transmitted directly to destination device 120 via the I/O interface 116 through the network 130A. The encoded visual data may also be stored onto a storage medium/server 130B for access by destination device 120.

The destination device 120 may include an I/O interface 126, a visual data decoder 124, and a display device 122. The I/O interface 126 may include a receiver and/or a modem. The I/O interface 126 may acquire encoded visual data from the source device 110 or the storage medium/server 130B. The visual data decoder 124 may decode the encoded visual data. The display device 122 may display the decoded visual data to a user. The display device 122 may be integrated with the destination device 120, or may be external to the destination device 120 which is configured to interface with an external display device.

The visual data encoder 114 and the visual data decoder 124 may operate according to a visual data coding standard, such as video coding standard or still picture coding standard and other current and/or further standards.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific visual data codecs, the disclosed techniques are applicable to other coding technologies also. Furthermore, while some embodiments describe coding steps in detail, it will be understood that corresponding steps decoding that undo the coding will be implemented by a decoder. Furthermore, the term visual data processing encompasses visual data coding or compression, visual data decoding or decompression and visual data transcoding in which visual data are represented from one compressed format into another compressed format or at a different compressed bitrate.

### 1. Brief Summary

A neural network-based image and video compression method comprising an entropy coding engine, wherein the samples of the latent representation are included in (or obtained from) a bitstream if the outcome of a determination step is true. The determination step is performed according to statistical parameters obtained by an estimation module.

### 2. Introduction

The past decade has witnessed the rapid development of deep learning in a variety of areas, especially in computer vision and image processing. Inspired from the great success of deep learning technology to computer vision areas, many researchers have shifted their attention from conventional image/video compression techniques to neural image/video compression technologies. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable rate-distortion (R-D) performance with Versatile Video Coding (VVC), the latest video coding standard developed by Joint Video Experts Team (JVET) with experts from MPEG and VCEG. With the performance of neural image compression continually being improved, neural network-based video compression has become an actively developing research area. However, neural network-based video coding still remains in its infancy due to the inherent difficulty of the problem.

### 2.1. Image/Video Compression

Image/video compression usually refers to the computing technology that compresses image/video into binary code to facilitate storage and transmission. The binary codes may or may not support losslessly reconstructing the original image/video, termed lossless compression and lossy compression. Most of the efforts are devoted to lossy compression since lossless reconstruction is not necessary in most scenarios. Usually the performance of image/video compression algorithms is evaluated from two aspects, i.e. compression ratio and reconstruction quality. Compression ratio is directly related to the number of binary codes, the less the better; Reconstruction quality is measured by comparing the reconstructed image/video with the original image/video, the higher the better.

Image/video compression techniques can be divided into two branches, the classical video coding methods and the neural-network-based video compression methods. Classical video coding schemes adopt transform-based solutions, in which researchers have exploited statistical dependency in the latent variables (e.g., DCT or wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs.

In the last three decades, a series of classical video coding standards have been developed to accommodate the increasing visual content. The international standardization organizations ISO/IEC has two expert groups namely Joint Photographic Experts Group (JPEG) and Moving Picture Experts Group (MPEG), and ITU-T also has its own Video Coding Experts Group (VCEG) which is for standardization of image/video coding technology. The influential video coding standards published by these organizations include JPEG, JPEG 2000, H.262, H.264/AVC and H.265/HEVC. After H.265/HEVC, the Joint Video Experts Team (JVET) formed by MPEG and VCEG has been working on a new video coding standard Versatile Video Coding (VVC). The first version of VVC was released in July 2020. An average of 50% bitrate reduction is reported by VVC under the same visual quality compared with HEVC.

Neural network-based image/video compression is not a new invention since there were a number of researchers working on neural network-based image coding. But the network architectures were relatively shallow, and the performance was not satisfactory. Benefit from the abundance of data and the support of powerful computing resources, neural network-based methods are better exploited in a variety of applications. At present, neural network-based image/video compression has shown promising improvements, confirmed its feasibility. Nevertheless, this technology is still far from mature and a lot of challenges need to be addressed.

### 2.2. Neural Networks

Neural networks, also known as artificial neural networks (ANN), are the computational models used in machine learning technology which are usually composed of multiple processing layers and each layer is composed of multiple simple but non-linear basic computational units. One benefit of such deep networks is believed to be the capacity for processing data with multiple levels of abstraction and converting data into different kinds of representations. Note that these representations are not manually designed; instead, the deep network including the processing layers is learned from massive data using a general machine learning procedure. Deep learning eliminates the necessity of handcrafted representations, and thus is regarded useful especially for processing natively unstructured data, such as acoustic and visual signal, whilst processing such data has been a longstanding difficulty in the artificial intelligence field.

### 2.3. Neural Networks for Image Compression

Existing neural networks for image compression methods can be classified in two categories, i.e., pixel probability modeling and auto-encoder. The former one belongs to the predictive coding strategy, while the latter one is the transform-based solution. Sometimes, these two methods are combined together in literature.

### 2.3.1. Pixel Probability Modeling

According to Shannon's information theory, the optimal method for lossless coding can reach the minimal coding rate—log₂p(x) where p(x) is the probability of symbol x. A number of lossless coding methods were developed in literature and among them arithmetic coding is believed to be among the optimal ones. Given a probability distribution p(x), arithmetic coding ensures that the coding rate to be as close as possible to its theoretical limit—log₂p(x) without considering the rounding error. Therefore, the remaining problem is to how to determine the probability, which is however very challenging for natural image/video due to the curse of dimensionality.

Following the predictive coding strategy, one way to model p(x) is to predict pixel probabilities one by one in a raster scan order based on previous observations, where x is an image.

$$p ( x ) = p ( {x}_{1} ) p ( {x}_{2} \vert {x}_{1} ) … p ( {x}_{i} \vert {x}_{1} , … , {x}_{i - 1} ) … p ( {x}_{m \times n} \vert {x}_{1} , … , {x}_{m \times n - 1} ) \qquad ( 1 )$$

where m and n are the height and width of the image, respectively. The previous observation is also known as the context of the current pixel. When the image is large, it can be difficult to estimate the conditional probability, thereby a simplified method is to limit the range of its context.

$$( 2 )$$

$$p ( x ) = \text{} p ( {x}_{1} ) p ( {x}_{2} \vert {x}_{1} ) \text{} … p ( {x}_{i} \vert {x}_{i - k} , … , {x}_{i - 1} ) … p ( {x}_{m \times n} \vert {x}_{m \times n - k} , … , {x}_{m \times n - 1} )$$

where k is a pre-defined constant controlling the range of the context.

It should be noted that the condition may also take the sample values of other color components into consideration. For example, when coding the RGB color component, R sample is dependent on previously coded pixels (including R/G/B samples), the current G sample may be coded according to previously coded pixels and the current R sample, while for coding the current B sample, the previously coded pixels and the current R and G samples may also be taken into consideration. Neural networks were originally introduced for computer vision tasks and have been proven to be effective in regression and classification problems. Therefore, it has been proposed using neural networks to estimate the probability of p (xᵢ) given its context x₁, x₂, . . . , xᵢ₋₁. In [7], the pixel probability is proposed for binary images, i.e., xᵢ∈{−1, +1}. The neural autoregressive distribution estimator (NADE) is designed for pixel probability modeling, where is a feed-forward network with a single hidden layer. A similar work is presented in an existing design, where the feed-forward network also has connections skipping the hidden layer, and the parameters are also shared. Experiments are performed on the binarized MNIST dataset. In an existing design, NADE is extended to a real-valued model RNADE, where the probability p (xᵢ|x₁, . . . , xᵢ₋₁) is derived with a mixture of Gaussians. Their feed-forward network also has a single hidden layer, but the hidden layer is with rescaling to avoid saturation and uses rectified linear unit (ReLU) instead of sigmoid. In an existing design, NADE and RNADE are improved by using reorganizing the order of the pixels and with deeper neural networks. Designing advanced neural networks plays an important role in improving pixel probability modeling. In an existing design, multi-dimensional long short-term memory (LSTM) is proposed, which is working together with mixtures of conditional Gaussian scale mixtures for probability modeling. LSTM is a special kind of recurrent neural networks (RNNs) and is proven to be good at modeling sequential data. The spatial variant of LSTM is used for images later in an existing design. Several different neural networks are studied, including RNNs and CNNs namely PixelRNN and PixelCNN, respectively. In PixelRNN, two variants of LSTM, called row LSTM and diagonal BILSTM are proposed, where the latter is specifically designed for images. PixelRNN incorporates residual connections to help train deep neural networks with up to 12 layers. In PixelCNN, masked convolutions are used to suit for the shape of the context. Comparing with previous works, PixelRNN and PixelCNN are more dedicated to natural images: they consider pixels as discrete values (e.g., 0, 1, . . . , 255) and predict a multinomial distribution over the discrete values; they deal with color images in RGB color space; they work well on large-scale image dataset ImageNet. In an existing design, Gated PixelCNN is proposed to improve the PixelCNN, and achieves comparable performance with PixelRNN but with much less complexity. In an existing design, PixelCNN++ is proposed with the following improvements upon PixelCNN: a discretized logistic mixture likelihood is used rather than a 256-way multinomial distribution; down-sampling is used to capture structures at multiple resolutions; additional short-cut connections are introduced to speed up training; dropout is adopted for regularization; RGB is combined for one pixel. In an existing design, PixelSNAIL is proposed, in which casual convolutions are combined with self-attention.

Most of the above methods directly model the probability distribution in the pixel domain. Some researchers also attempt to model the probability distribution as a conditional one upon explicit or latent representations. That being said, it may be estimated that

$$p ( x \vert h ) = {\prod }_{i = 1}^{m \times n} p ( {x}_{i} \vert {x}_{1} , … , {x}_{i - 1} , h ) \qquad ( 3 )$$

where h is the additional condition and p(x)=p(h)p(x|h), meaning the modeling is split into an unconditional one and a conditional one. The additional condition can be image label information or high-level representations.

### 2.3.2. Auto-Encoder

Auto-encoder originates from the well-known work proposed by Hinton and Salakhutdinov. The method is trained for dimensionality reduction and consists of two parts: encoding and decoding. The encoding part converts the high-dimension input signal to low-dimension representations, typically with reduced spatial size but a greater number of channels. The decoding part attempts to recover the high-dimension input from the low-dimension representation. Auto-encoder enables automated learning of representations and eliminates the need of hand-crafted features, which is also believed to be one of the most important advantages of neural networks.

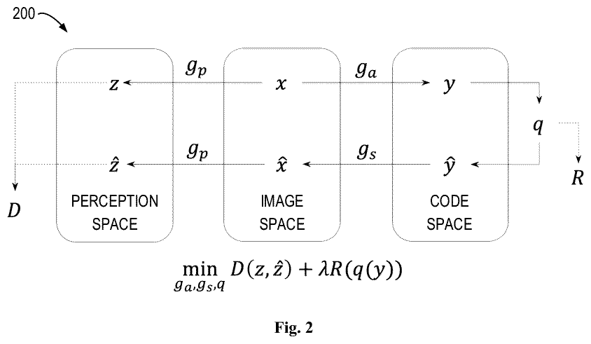

FIG. 2 illustrates a typical transform coding scheme. The original image x is transformed by the analysis network gₐ to achieve the latent representation y. The latent representation y is quantized and compressed into bits. The number of bits R is used to measure the coding rate. The quantized latent representation y is then inversely transformed by a synthesis network gₛ to obtain the reconstructed image R. The distortion is calculated in a perceptual space by transforming x and & with the function gₚ.

It is intuitive to apply auto-encoder network to lossy image compression. It only need to encode the learned latent representation from the well-trained neural networks. However, it is not trivial to adapt auto-encoder to image compression since the original auto-encoder is not optimized for compression thereby not efficient by directly using a trained auto-encoder. In addition, there exist other major challenges: First, the low-dimension representation should be quantized before being encoded, but the quantization is not differentiable, which is required in backpropagation while training the neural networks. Second, the objective under compression scenario is different since both the distortion and the rate need to be take into consideration. Estimating the rate is challenging. Third, a practical image coding scheme needs to support variable rate, scalability, encoding/decoding speed, interoperability. In response to these challenges, a number of researchers have been actively contributing to this area. The prototype auto-encoder for image compression is in FIG. 2, which can be regarded as a transform coding strategy. The original image x is transformed with the analysis network y=gₐ (x), where y is the latent representation which will be quantized and coded. The synthesis network will inversely transform the quantized latent representation ŷ back to obtain the reconstructed image \hat{x}=gₛ (ŷ). The framework is trained with the rate-distortion loss function, i.e., [symbol] =D+λR, where D is the distortion between x and \hat{x}, R is the rate calculated or estimated from the quantized representation ŷ, and λ is the Lagrange multiplier. It should be noted that D can be calculated in either pixel domain or perceptual domain. All existing research works follow this prototype and the difference might only be the network structure or loss function.

In terms of network structure, RNNs and CNNs are the most widely used architectures. In the RNNs relevant category, Toderici et al. propose a general framework for variable rate image compression using RNN. They use binary quantization to generate codes and do not consider rate during training. The framework indeed provides a scalable coding functionality, where RNN with convolutional and deconvolution layers is reported to perform decently. Toderici et al. then proposed an improved version by upgrading the encoder with a neural network similar to PixelRNN to compress the binary codes. The performance is reportedly better than JPEG on Kodak image dataset using MS-SSIM evaluation metric. Johnston et al. further improve the RNN-based solution by introducing hidden-state priming. In addition, an SSIM-weighted loss function is also designed, and spatially adaptive bitrates mechanism is enabled. They achieve better results than BPG on Kodak image dataset using MS-SSIM as evaluation metric. Covell et al. support spatially adaptive bitrates by training stop-code tolerant RNNs.

Ballé et al. proposes a general framework for rate-distortion optimized image compression. The use multiary quantization to generate integer codes and consider the rate during training, i.e. the loss is the joint rate-distortion cost, which can be MSE or others. They add random uniform noise to stimulate the quantization during training and use the differential entropy of the noisy codes as a proxy for the rate. They use generalized divisive normalization (GDN) as the network structure, which consists of a linear mapping followed by a nonlinear parametric normalization. The effectiveness of GDN on image coding is verified in an existing design. Ballé et al. then propose an improved version, where they use 3 convolutional layers each followed by a down-sampling layer and a GDN layer as the forward transform. Accordingly, they use 3 layers of inverse GDN each followed by an up-sampling layer and convolution layer to stimulate the inverse transform. In addition, an arithmetic coding method is devised to compress the integer codes. The performance is reportedly better than JPEG and JPEG 2000 on Kodak dataset in terms of MSE. Furthermore, Ballé et al. improve the method by devising a scale hyper-prior into the auto-encoder. They transform the latent representation y with a subnet hₐ to z=hₐ (y) and z will be quantized and transmitted as side information. Accordingly, the inverse transform is implemented with a subnet hₛ attempting to decode from the quantized side information \hat{z} to the standard deviation of the quantized ŷ, which will be further used during the arithmetic coding of y. On the Kodak image set, their method is slightly worse than BPG in terms of PSNR. D. Minnen et al. further exploit the structures in the residue space by introducing an autoregressive model to estimate both the standard deviation and the mean. In an existing design, Z. Cheng et al. use Gaussian mixture model to further remove redundancy in the residue. The reported performance is on par with VVC on the Kodak image set using PSNR as evaluation metric.

### 2.3.3. Hyper Prior Model

In the transform coding approach to image compression, the encoder subnetwork (section 2.3.2) transforms the image vector x using a parametric analysis transform gₐ (x, Ø_{g}) into a latent representation y, which is then quantized to form ŷ. Because ŷ is discrete-valued, it can be losslessly compressed using entropy coding techniques such as arithmetic coding and transmitted as a sequence of bits.

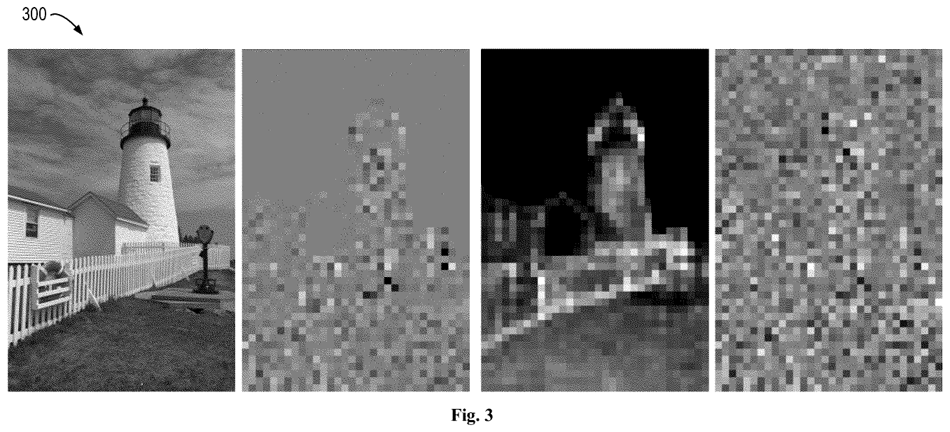

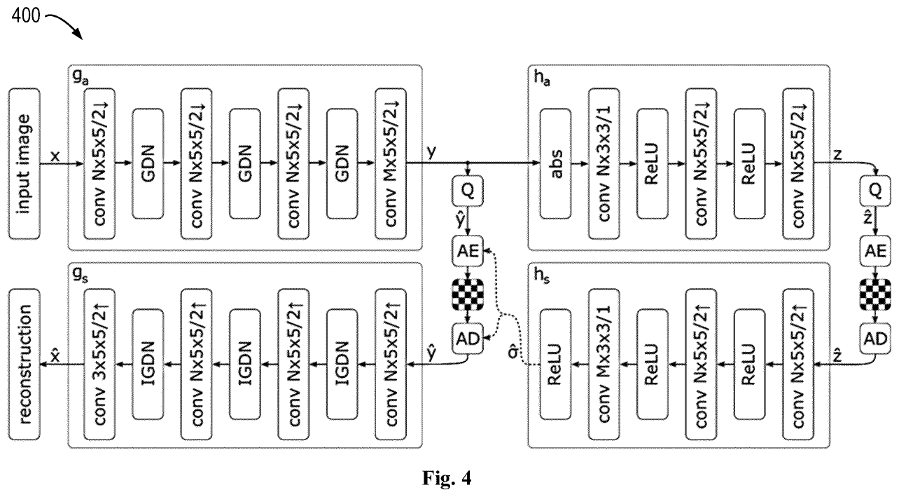

As evident from the middle left and middle right image of FIG. 3, there are significant spatial dependencies among the elements of ŷ. Notably, their scales (middle right image) appear to be coupled spatially. In an existing design, an additional set of random variables \hat{z} are introduced to capture the spatial dependencies and to further reduce the redundancies. In this case the image compression network is depicted in FIG. 4.

In FIG. 4, the left hand of the models is the encoder gₐ and decoder gₛ (explained in section 2.3.2). The right-hand side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses it to compress and transmit the quantized image representation ŷ. The decoder first recovers \hat{z} from the compressed signal. It then uses hₛ to obtain σ, which provides it with the correct probability estimates to successfully recover ŷ as well. It then feeds ŷ into gₛ to obtain the reconstructed image.

When the hyper encoder and hyper decoder are added to the image compression network, the spatial redundancies of the quantized latent ŷ are reduced. The rightmost image in FIG. 3 correspond to the quantized latent when hyper encoder/decoder are used. Compared to middle right image, the spatial redundancies are significantly reduced, as the samples of the quantized latent are less correlated. FIG. 3 illustrates an image from the Kodak dataset and different representations of the image. The leftmost image in FIG. 3 shows an image from the Kodak dataset. The middle left image in FIG. 3 shows visualization of a latent representation y of that image. The middle right image in FIG. 3 shows standard deviations σ of the latent. The rightmost image in FIG. 3 shows latents y after the hyper prior (hyper encoder and decoder) network is introduced.

FIG. 4 illustrates a network architecture of an autoencoder implementing the hyperprior model. The left side shows an image autoencoder network, the right side corresponds to the hyperprior subnetwork. The analysis and synthesis transforms are denoted as gₐ and gₐ. Q represents quantization, and AE, AD represent arithmetic encoder and arithmetic decoder, respectively. The hyperprior model consists of two subnetworks, hyper encoder (denoted with hₐ) and hyper decoder (denoted with hₛ). The hyper prior model generates a quantized hyper latent (\hat{z}) which comprises information about the probability distribution of the samples of the quantized latent ŷ. \hat{z} is included in the bitsteam and transmitted to the receiver (decoder) along with ŷ.

### 2.3.4. Context Model

Although the hyper prior model improves the modelling of the probability distribution of the quantized latent ŷ, additional improvement can be obtained by utilizing an autoregressive model that predicts quantized latents from their causal context (Context Model).

The term auto-regressive means that the output of a process is later used as input to it. For example, the context model subnetwork generates one sample of a latent, which is later used as input to obtain the next sample.

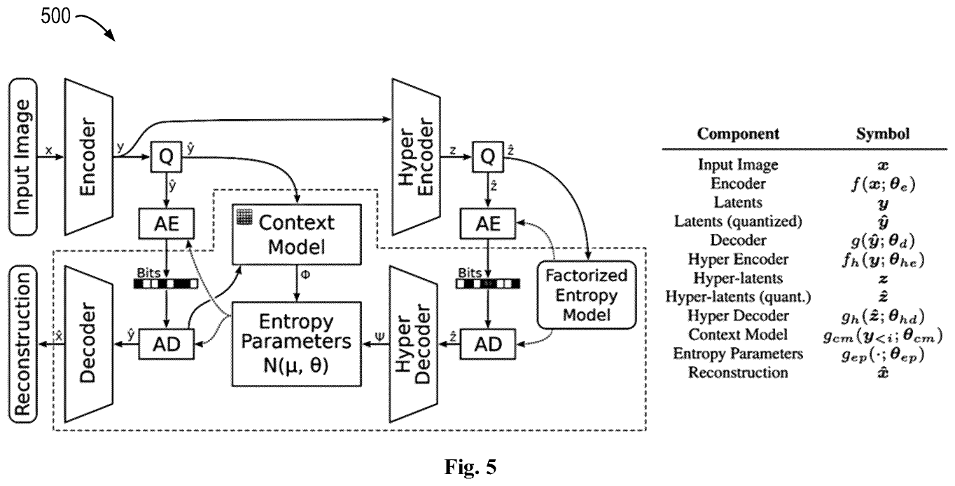

An existing design utilizes a joint architecture where both hyper prior model subnetwork (hyper encoder and hyper decoder) and a context model subnetwork are utilized. The hyper prior and the context model are combined to learn a probabilistic model over quantized latents ŷ, which is then used for entropy coding. As depicted in FIG. 5, the outputs of context subnetwork and hyper decoder subnetwork are combined by the subnetwork called Entropy Parameters, which generates the mean u and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

FIG. 5 illustrates a block diagram of a combined model. The combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The highlighted region corresponds to the components that are executed by the receiver (i.e. a decoder) to recover an image from a compressed bitstream.

Typically, the latent samples are modeled as gaussian distribution or gaussian mixture models (not limited to). In an existing design and according to the FIG., the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 2.3.5. The Encoding Process Using Joint Auto-Regressive Hyper Prior Model

FIG. 5 corresponds to the state-of-the-art compression method. In this section and the next, the encoding and decoding processes will be described separately.

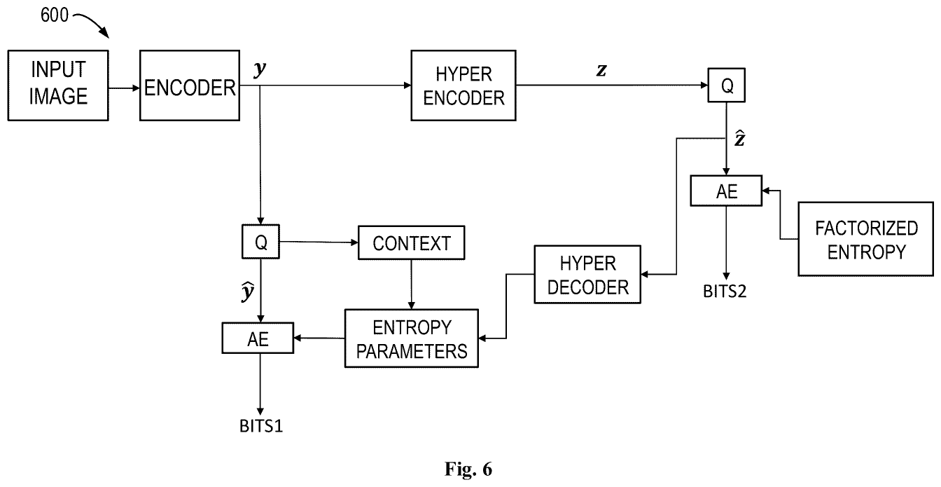

The FIG. 6 depicts the encoding process. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order. The modules hyper encoder, context, hyper decoder, and entropy parameters subnetworks are used to estimate the probability distributions of the samples of the quantized latent ŷ, the latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. In an existing design, the entropy parameters module is used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent ŷ into bitstream (bits1). Finally, the first and the second bitstream are transmitted to the decoder as result of the encoding process. It is noted that the other names can be used for the modules described above.

In the above description, the all of the elements in FIG. 6 are collectively called encoder. The analysis transform that converts the input image into latent representation is also called an encoder (or auto-encoder).

### 2.3.6. The Decoding Process Using Joint Auto-Regressive Hyper Prior Model

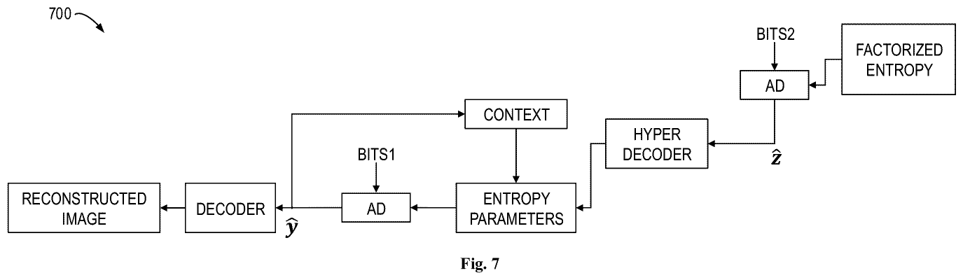

FIG. 7 depicts the decoding process separately. In the decoding process, the decoder first receives the first bitstream (bits1) and the second bitstream (bits2) that are generated by a corresponding encoder.

The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore, the exact same probability distributions can be obtained in the decoder (as in encoder), which is essential for reconstructing the quantized latent ŷ without any loss. As a result, the identical version of the quantized latent ŷ that was obtained in the encoder can be obtained in the decoder.

After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization. Finally, the fully reconstructed quantized latent ŷ is input to the synthesis transform (denoted as decoder in FIG. 7) module to obtain the reconstructed image.

In the above description, the all of the elements in FIG. 7 are collectively called decoder. The synthesis transform that converts the quantized latent into reconstructed image is also called a decoder (or auto-decoder).

### 2.4. Neural Networks for Video Compression

Similar to conventional video coding technologies, neural image compression serves as the foundation of intra compression in neural network-based video compression, thus development of neural network-based video compression technology comes later than neural network-based image compression but needs far more efforts to solve the challenges due to its complexity. Starting from 2017, a few researchers have been working on neural network-based video compression schemes. Compared with image compression, video compression needs efficient methods to remove inter-picture redundancy. Inter-picture prediction is then a crucial step in these works. Motion estimation and compensation is widely adopted but is not implemented by trained neural networks until recently.

Studies on neural network-based video compression can be divided into two categories according to the targeted scenarios: random access and the low-latency. In random access case, it requires the decoding can be started from any point of the sequence, typically divides the entire sequence into multiple individual segments and each segment can be decoded independently. In low-latency case, it aims at reducing decoding time thereby usually merely temporally previous frames can be used as reference frames to decode subsequent frames.

### 2.4.1. Low-Latency

Chen et al. are the first to propose a video compression scheme with trained neural networks. They first split the video sequence frames into blocks and each block will choose one from two available modes, either intra coding or inter coding. If intra coding is selected, there is an associated auto-encoder to compress the block. If inter coding is selected, motion estimation and compensation are performed with tradition methods and a trained neural network will be used for residue compression. The outputs of auto-encoders are directly quantized and coded by the Huffman method.

Chen et al. propose another neural network-based video coding scheme with PixelMotionCNN. The frames are compressed in the temporal order, and each frame is split into blocks which are compressed in the raster scan order. Each frame will firstly be extrapolated with the preceding two reconstructed frames. When a block is to be compressed, the extrapolated frame along with the context of the current block are fed into the PixelMotionCNN to derive a latent representation. Then the residues are compressed by the variable rate image scheme. This scheme performs on par with H.264.

Lu et al. propose the real-sense end-to-end neural network-based video compression framework, in which all the modules are implemented with neural networks. The scheme accepts current frame and the prior reconstructed frame as inputs and optical flow will be derived with a pre-trained neural network as the motion information. The motion information will be warped with the reference frame followed by a neural network generating the motion compensated frame. The residues and the motion information are compressed with two separate neural auto-encoders. The whole framework is trained with a single rate-distortion loss function. It achieves better performance than H.264.

Rippel et al. propose an advanced neural network-based video compression scheme. It inherits and extends traditional video coding schemes with neural networks with the following major features: 1) using only one auto-encoder to compress motion information and residues; 2) motion compensation with multiple frames and multiple optical flows; 3) an on-line state is learned and propagated through the following frames over time. This scheme achieves better performance in MS-SSIM than HEVC reference software.

J. Lin et al. propose an extended end-to-end neural network-based video compression framework. In this solution, multiple frames are used as references. It is thereby able to provide more accurate prediction of current frame by using multiple reference frames and associated motion information. In addition, motion field prediction is deployed to remove motion redundancy along temporal channel. Postprocessing networks are also introduced in this work to remove reconstruction artifacts from previous processes. The performance is better than H.265 by a noticeable margin in terms of both PSNR and MS-SSIM.

Eirikur et al. propose scale-space flow to replace commonly used optical flow by adding a scale parameter. It is reportedly achieving better performance than H.264.

Z. Hu et al. propose a multi-resolution representation for optical flows. Concretely, the motion estimation network produces multiple optical flows with different resolutions and let the network to learn which one to choose under the loss function. The performance is slightly improved and better than H.265.

### 2.4.2. Random Access

Wu et al. propose a neural network-based video compression scheme with frame interpolation. The key frames are first compressed with a neural image compressor and the remaining frames are compressed in a hierarchical order. They perform motion compensation in the perceptual domain, i.e. deriving the feature maps at multiple spatial scales of the original frame and using motion to warp the feature maps, which will be used for the image compressor. The method is reportedly on par with H.264.

Djelouah et al. propose a method for interpolation-based video compression, wherein the interpolation model combines motion information compression and image synthesis, and the same auto-encoder is used for image and residual.

Amirhossein et al. propose a neural network-based video compression method based on variational auto-encoders with a deterministic encoder. Concretely, the model consists of an auto-encoder and an auto-regressive prior. Different from previous methods, this method accepts a group of pictures (GOP) as inputs and incorporates a 3D autoregressive prior by taking into account of the temporal correlation while coding the laten representations. It provides comparative performance as H.265.

### 2.5. Preliminaries

Almost all the natural image/video is in digital format. A grayscale digital image can be represented by x ∈ [symbol] , where [symbol] is the set of values of a pixel, m is the image height and n is the image width. For example, [symbol] ={0, 1, 2, . . . ,255} is a common setting and in this case | [symbol] |=256=2⁸, thus the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x ∈ [symbol] with three separate channels storing Red, Green and Blue information. Similar to the 8-bit grayscale image, an uncompressed 8-bit RGB image has 24 bpp. Digital images/videos can be represented in different color spaces. The neural network-based video compression schemes are mostly developed in RGB color space while the traditional codecs typically use YUV color space to represent the video sequences. In YUV color space, an image is decomposed into three channels, namely Y, Cb and Cr, where Y is the luminance component and Cb/Cr are the chroma components. The benefits come from that Cb and Cr are typically down sampled to achieve pre-compression since human vision system is less sensitive to chroma components.

A color video sequence is composed of multiple color images, called frames, to record scenes at different timestamps. For example, in the RGB color space, a color video can be denoted by X={x₀, x₁, . . . , xₜ, . . . , x_{T-1}} where T is the number of frames in this video sequence, x ∈ [symbol] . If m=1080, n=1920, | [symbol] |=2⁸, and the video has 50 frames-per-second (fps), then the data rate of this uncompressed video is 1920×1080×8×3×50=2,488,320,000 bits-per-second (bps), about 2.32 Gbps, which needs a lot storage thereby definitely needs to be compressed before transmission over the internet.

Usually the lossless methods can achieve compression ratio of about 1.5 to 3 for natural images, which is clearly below requirement. Therefore, lossy compression is developed to achieve further compression ratio, but at the cost of incurred distortion. The distortion can be measured by calculating the average squared difference between the original image and the reconstructed image, i.e., mean-squared-error (MSE). For a grayscale image, MSE can be calculated with the following equation.

$$M S E = \frac{{‖ x - \hat{x} ‖}^{2}}{m \times n} \qquad ( 4 )$$

Accordingly, the quality of the reconstructed image compared with the original image can be measured by peak signal-to-noise ratio (PSNR):

$$P S N R = 10 \times {log}_{10} \frac{{( max ( ) )}^{2}}{M S E} \qquad ( 5 )$$

where max ( [symbol] ) is the maximal value in [symbol] , e.g., 255 for 8-bit grayscale images. There are other quality evaluation metrics such as structural similarity (SSIM) and multi-scale SSIM (MS-SSIM).

To compare different lossless compression schemes, it is sufficient to compare either the compression ratio given the resulting rate or vice versa. However, to compare different lossy compression methods, it has to take into account both the rate and reconstructed quality. For example, to calculate the relative rates at several different quality levels, and then to average the rates, is a commonly adopted method; the average relative rate is known as Bjontegaard's delta-rate (BD-rate). There are other important aspects to evaluate image/video coding schemes, including encoding/decoding complexity, scalability, robustness, and so on.

### 2.5.1. Quantization and Entropy Coding

The terms quantization and entropy coding can be defined as follows:

Quantization, in mathematics and digital signal processing, is the process of mapping input values from a large set (often a continuous set) to output values in a (countable) smaller set, often with a finite number of elements. Rounding and truncation are typical examples of quantization processes. Quantization is involved to some degree in nearly all digital signal processing, as the process of representing a signal in digital form ordinarily involves rounding. Quantization also forms the core of essentially all lossy compression algorithms.

The equation of quantization can be as follows:

$$\hat{y} = round ( \frac{y}{Δ} ) \qquad ( eq . 1 )$$

Wherein the ŷ is the quantized value, y is the sample to be quantized and A is the quantization step size. For example, according to the equation 1 above, if the quantization step size is increased, the quantized value ŷ will get smaller and less bits will be needed to encode the quantized sample. In other words, the increased quantization step size results in a coarser quantization. On the other hand, a smaller Δ (which is usually a positive number) results in a finer quantization and higher number of bits to encode ŷ into the bitstream. An entropy coding is a general lossless data compression method that encodes symbols by using an amount of bits inversely proportional to the probability of the symbols. A term used to denote some compression algorithms, which works based on the probability distribution of source symbols. Huffman coding and arithmetic coding are two typical algorithms of this kind. In order to perform entropy coding, the statistical properties (e.g. probability distribution) of the symbols must be known.

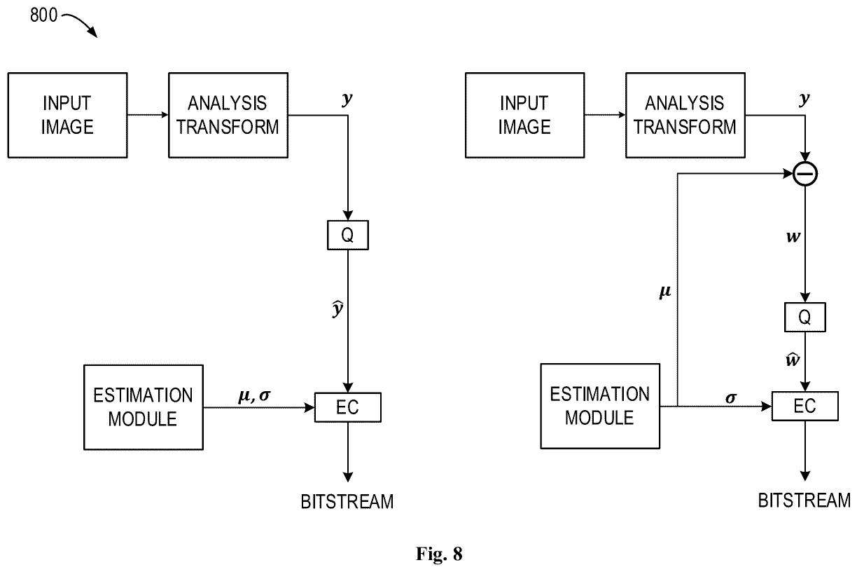

FIG. 8 illustrates two possible implementations of the entropy coding and quantization processes in NN-based image compression. Encoder perspectives are depicted.

In FIG. 8, two possible implementations of the encoder of an NN-based image compression method are depicted. The encoder of an NN-based image compression method is composed of 4 modules. The first module is the analysis transform. The analysis transform transforms the input image into latent representation y. The transformed representation y is usually easier to compress than the input image, since the analysis transform is designed to eliminate redundancies in the input image signal. The second module is the Estimation Module, which estimates the statistical properties of the latent representation. The statistical properties might include a mean value (denoted by μ), a variance (denoted σ) or higher order moments. The third module is the quantization module, which converts the continuous latent representation signal into quantized discrete values. Finally, the fourth module is the entropy coding (denoted by EC), which converts the quantized symbol values into bitstream using the statistical properties generated by the estimation module.

Two slightly different implementation alternatives exist for the encoder, based on how the mean value μ is used. In the first implementation the entropy coding module receives the mean value and the other statistics (like the variance σ) as inputs, and uses them to encode the quantized latent symbols ŷ into bitstream. In the second implementation alternative the mean value is first subtracted from latent symbols y to obtain the residual samples w. Then the residual samples are quantized by the quantization module to obtain quantized residual samples ŵ. The entropy coding module converts the quantized residual samples into bitstream using the statistical information generated by the estimation module. The statistical information might include, for example, variance σ.

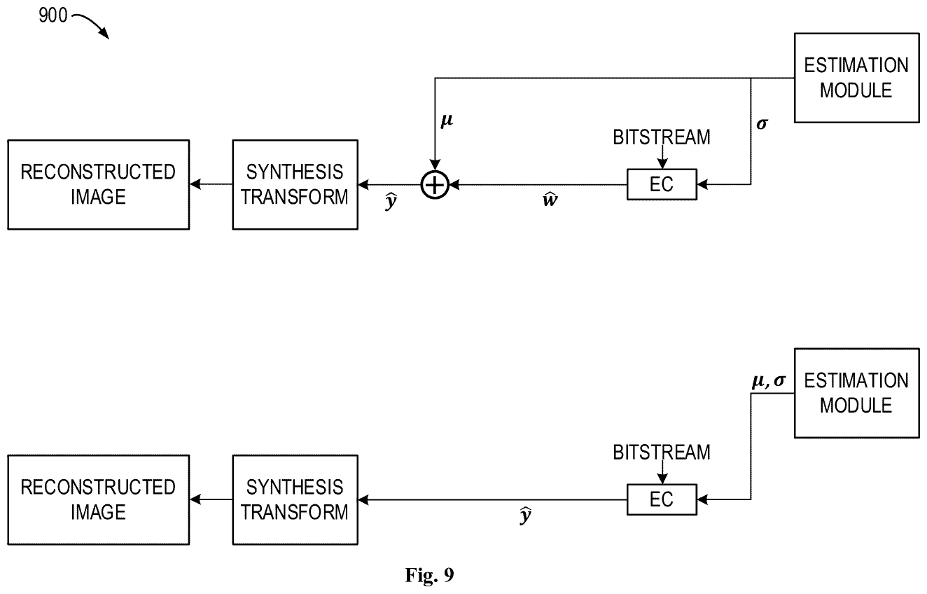

FIG. 9 illustrates corresponding decoder implementations for the encoder implementations shown in FIG. 8. FIG. 9 describes two possible alternative implementations of the decoder in an NN-based video compression method. According to the first alternative, the estimation module estimates the mean values μ and other statistical properties (e.g. variance σ). The variance and optimally other statistical information are used by the entropy coder (denoted by EC) to decode the bitstream into quantized residual samples ŵ. Later the estimated mean values μ and the quantized residual samples ŵ are added together to obtain the quantized latent samples ŷ. ŷ is finally transformed into reconstructed picture by a synthesis transform. The first alternative decoder implementation is depicted in the upper flowchart in FIG. 9.

According to the second alternative, the estimation module estimates the mean values μ and other statistical properties (e.g. variance σ). The mean, variance and optimally other statistical information are used by the entropy coder (denoted by EC) to decode the bitstream into quantized residual samples quantized latent samples ŷ. ŷ is finally transformed into reconstructed picture by a synthesis transform. The second alternative decoder implementation is depicted in the bottom flowchart in FIG. 9.

In the above a sample of quantized latent is denoted by ŷ. It is noted that the sample is not necessarily a scalar value, it might be a vector and might contain multiple elements. In the rest of the application a sample can be denoted by ŷ[i,j], ŷ[:,i,j], or ŷ[c,i,j]. In the latter, the “:” is used to denote that there is a third dimension and is used to stress that the sample has multiple elements.

### 3. Problems

### 3.1. the Core Problem

In NN-based image or video compression architectures most of the modules are massively parallelizable, (like the synthesis transform in FIG. 9, hence these processes can be accelerated considerably by a GPU. On the other hand, the process of entropy coding (or decoding) consists of converting input samples into a sequence of bits (i.e. the bitstream), and therefore it is inherently a sequential process. Due to its sequential nature, entropy coding module is not parallelizable, therefore it is the bottleneck process and responsible for the slowness of the processing in NN-based compression methods.

### 4. Detailed Solutions

The detailed solutions below should be considered as examples to explain general concepts. These solutions should not be interpreted in a narrow way. Furthermore, these solutions can be combined in any manner.

### 4.1. Target of the Solution

The solution targets skipping of the entropy coding process under certain conditions, in order to reduce the time spent for entropy coding and hence increasing the encoding/decoding speed.

### 4.2. Core of the Solution

According to the core of the solution, the samples of y and/or w are divided into at least two subsets, based on the statistical properties. At the encoder the samples of the first subset are encoded into a bitstream whereas the samples of the second subset are not encoded into the bitstream. At the decoder the samples of the first subset are decoded from a bitstream, whereas the samples of the second bitstream are not decoded from the bitstream and their values are inferred.

### 4.2.1. Encoding Process

According to the solution:
An input image is transformed to obtain the quantized latent samples ŷ (or quantized residual latent ŵ samples) by a first subnetwork.
Statistical parameters σ (e.g. variance parameters) are estimated by the estimation module.
The samples of quantized latent ŷ (or the residual latent ŵ) are divided into at least two subsets, ŷ₁ and ŷ₂ (or ŵ₁ and ŵ₂), according to the estimated statistical parameters σ, wherein each subset comprises at least one sample.
The quantized latent samples belonging to first subset ŷ₁ are encoded by an entropy coding module using σ and are included in a bitstream.

### 4.2.2. Decoding Process

According to the solution:
Statistical parameters σ (e.g. variance parameters) are estimated by the estimation module.
The samples of quantized latent ŷ (or the residual latent ŵ) are divided into at least two subsets according to σ, wherein values of the samples of the first subset ŷ₁ (or ŵ₁) are to be decoded from a bitstream and values of the samples of the second subset ŷ₂ (or ŵ₂) are to be inferred.
The values of the samples belonging to first subset ŷ₁ (or ŵ₁) are decoded from a bitstream according to σ.
The values of the samples belonging to second subset ŷ₂ (or ŵ₂) are inferred.
The quantized latent samples ŷ (or the quantized residual latent samples ŵ) are processed by a second subnetwork (e.g. synthesis transform) to obtain the reconstructed picture.

### 4.3. Details of the Solution

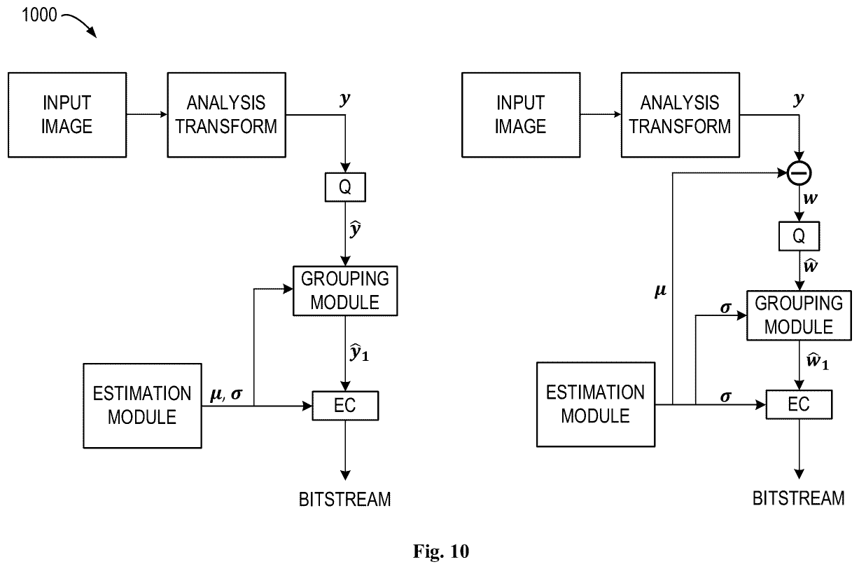

FIG. 10 depicts the implementation of the solution at the NN based image encoder. First the input image is transformed using an analysis transform to obtain the samples of the latent representation y. Afterwards the statistical parameters are estimated by an estimation module. The parameters might include a mean parameter μ representing the mean value of a probability distribution, and/or a variance parameter σ representing the variance value of a probability distribution. In one of the implementations of the solution (right figure in FIG. 10) the mean values μ are subtracted from the samples of latent y to obtain the residual latent samples w. Then a quantization module (denoted by Q) is used to quantize the latent or residual latent samples to obtain quantized samples ŷ or ŵ. The grouping module uses the statistical parameters (e.g. σ) to group the quantized samples into two groups, ŷ₁ and ŷ₂, and only samples of the first subset ŷ₁ (or ŵ₁) are sent to the entropy coder (denoted EC). The samples of ŷ₂ (or Ŵ₂) are not sent to the entropy coder, hence not included in the bistream. The samples sent to the entropy coder are processed by the entropy coder, and included in a bitstream. The samples that are not sent to the entropy coder are not processed by the entropy coder, or ignored by it. Therefore it is not included in the bitstream.

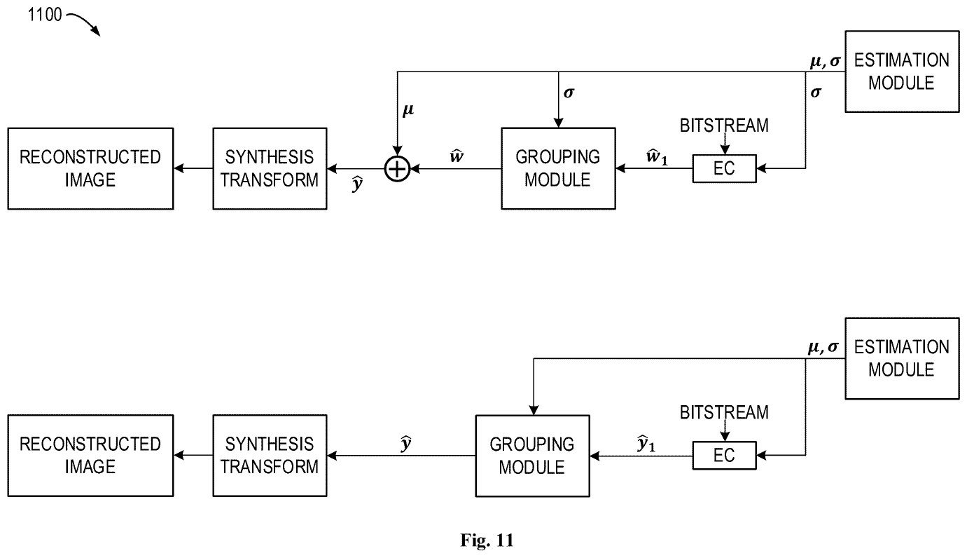

FIG. 10 illustrates two possible implementations of the encoder, and FIG. 11 illustrates two possible implementations of the decoder

FIG. 11 depicts the implementation of the solution at the NN based image decoder. First the statistical parameters are obtained by an estimation module. The parameters might include a mean parameter μ representing the mean value of a probability distribution, and/or a variance parameter σ representing the variance value of a probability distribution. For example the estimation module might comprise a neural network, and the input of the estimation module might be a bitstream. Using the statistical parameters obtained by the estimation module, the entropy coding module decodes the samples of the quantized residual latent ŵ (or quantized latent ŷ) belonging to the first subset (i.e. ŷ₁) from a bitstream. The grouping module is configured to determine which samples of ŷ corresponds to the first subset and the rest of the samples (that belong to the second subset) are inferred. The grouping module uses statistical parameters (e.g. μ, and/or σ) to determine which sample corresponds to which subset.

The inference of the values of the samples belonging to the second subset can comprise one of the following:
1. Setting the values of the samples belonging to the second subset equal to zero.
2. Setting the values of the samples belonging to the second subset equal to corresponding mean values μ that are estimated by the estimation module.
3. Setting the values of the samples belonging to the second subset equal to a constant scalar number.

For example, in bottom figure of FIG. 11, the entropy coding (EC) module receives the bitstream and decodes the values of the samples of ŷ₁. The entropy coding module uses the statistical parameters obtained by the estimation module to decode the values. ŷ₁ comprises only a subset of the samples of ŷ, therefore the grouping module is used to determine which of the samples of ŷ are included in the subset ŷ₁, and which of the samples are not decoded by the entropy coding (or decoding) process. The grouping module utilizes the statistical parameters (e.g. variance σ) to determine which of the samples of ŷ are decoded by the EC and which samples are not decoded.

There might be one statistical parameter value σ[i,j] corresponding to each sample of ŷ[i,j] (or ŵ[i,j]). The determination of whether a sample is decoded by EC or not can be based on a thresholding operation, wherein the statistical parameter value σ[i,j], or a function of it f(σ[i,j]) is compared with a threshold value. If the result of the comparison is true, the value of the sample at location ŷ[i,j] (or ŵ[i,j]) is set equal to a sample of ŷ₁. Otherwise the value of the sample at location ŷ[i,j] (or ŵ[i,j]) is inferred. In one example the value of the sample can be inferred equal to μ[i,j], which is a mean value corresponding to sample at location ŷ[i,j] (or ŵ[i,j]). In another example the value of the sample can be inferred equal to a constant predetermined value, such as zero.

After the values of samples in the first subset are decoded from the bitstream, and the samples of the second subset are inferred, the ŷ is reconstructed. ŷ is then processed by a synthesis transform to obtain the reconstructed picture.

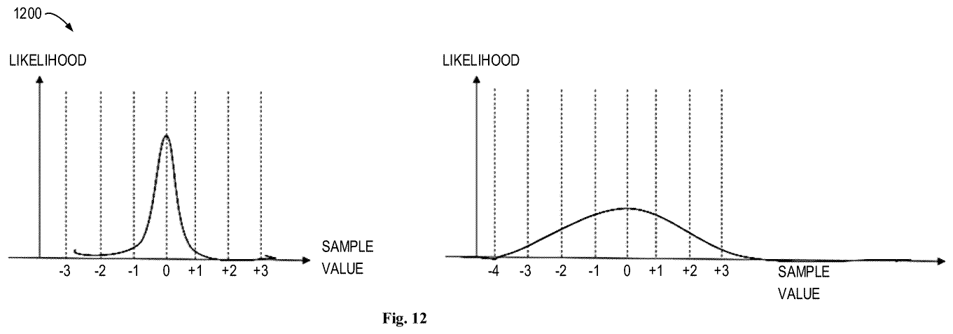

According to the solution the grouping process (into subsets) of the samples are based on the estimated statistical parameters. This is particularly useful since the statistical parameters indicate how “unclear” the value of a sample is. For example, the FIG. 12 exemplifies the probability distribution of a sample when the variance parameter is small (on the left) and the variance parameter is large (on the right). On the left, the value of the sample is very likely to be equal or very close to zero. And it is very unlikely to be 3, or −3, since the likelihood approaches 0 at those sample values. One can informally say that the sample is “more clear”, since he have confidence that it is likely to be zero. On the other hand, when the variance parameter is large (right figure in FIG. 12), the sample value can be more diverse. On the right there is considerable probability that the sample value is not equal to 0. Therefore, the sample is “unclear”.

FIG. 12 illustrates two possible probability distributions. The probability distribution of a sample when (on the left) the variance of the probability distribution is small, and when (on the right) it is large.

The solution takes advantage of the above observation by grouping the samples according to their corresponding statistical parameters. For example, if a sample is likely to be zero (small variance) it is grouped into one subset, whereas if the variance is large it is grouped into second subset. If the variance is small, the value of the signal is “clear” and very likely to be zero (or any other mean value that is at the center of the probability distribution). In this case, skipping the entropy coding process for this sample does not alter the result very much, since the value is already almost known. On the other hand, if the variance is large, the value of the samples can be different (its value is “unclear”), therefore in this case it is worthwhile to encode this samples in the bitstream.

The estimation module can comprise a neural network-based subnetwork. For example, the input of the estimation module can be a bitstream, and the output of the subnetwork can be the mean and variance parameters of a probability distribution. More specifically, the output of the estimation module can be mean and variance parameters of a gaussian probability distribution.

### Example Implementations of the Solution

1. Dividing of the samples of the quantized latent (or quantized residual latent) into at least 2 subsets comprises;
Grouping the samples of the quantized latent into blocks of size N by M,
Checking if the average of the variance corresponding to all of the samples comprised in a block are smaller than a threshold (or larger than a threshold).
Grouping the samples of the block into first subset if the outcome of the checking is true, and grouping into second subset if the outcome is false.

2. Dividing of the samples of the quantized latent (or quantized residual latent) into at least 2 subsets comprises;
Grouping the samples of the quantized latent into blocks of size N by M,
Checking if the variance corresponding to all of the samples comprised in a block are smaller than a threshold (or larger than a threshold).
Grouping the samples of the block into first subset if the outcome of the checking is true, and grouping into second subset if the outcome is false.

3. Dividing of the samples of the quantized latent (or quantized residual latent) into at least 2 subsets comprises;
Obtaining probabilities corresponding to each sample of the quantized latent using the variance parameter,
Grouping the samples of the quantized latent into blocks of size N by M,
Checking if probability of all of the samples comprised in a block are smaller than a threshold (or larger than a threshold).
Grouping the samples of the block into first subset if the outcome of the checking is true, and grouping into second subset if the outcome is false.

4. Dividing of the samples of the quantized latent (or quantized residual latent) into at least 2 subsets comprises;
Obtaining probabilities corresponding to each sample of the quantized latent using the variance parameter,
Grouping the samples of the quantized latent into blocks of size N by M,
Checking if the average probability of all of the samples comprised in a block are smaller a threshold (or larger than a threshold).
Grouping the samples of the block into first subset if the outcome of the checking is true, and grouping into second subset if the outcome is false.

In example 3 and 4, the probability of a sample is compared against a threshold to determine if the sample belongs to a first set or a second set. In one example probability of a sample is calculated as the probability that the value of the sample is equal to 0. In another example, the probability of the sample is calculated as the probability that the value of the sample is equal to a mean value that is estimated by the estimation module. In another example, the probability of the sample ŷ[i,j] is the probability of that the value of that sample is equal to μ[i,j], which is the mean value estimated by the estimation module. In this example the estimation module generates a mean value μ[i,j] corresponding to each sample of ŷ[i,j].

The probabilities of the sample can be obtained using the statistical parameters generated by the estimation module. For example, the estimation module might generate a mean parameter and a variance parameter for a gaussian distribution, which is a probability distribution that can be used to estimate the probability of a sample being equal to any value.

### 4.4. Benefits of the Solution

The solution targets skipping of the entropy coding process according to the statistical parameters, in order to reduce the time spent for entropy coding and hence increasing the encoding/decoding speed.

### 5. Embodiments

1. Decoder embodiment:

An image or video decoding method, comprising at least one of the steps of:
Obtaining at least one statistical parameter σ using an estimation module.
Obtaining at least one sample value using bitstream and the σ, denoted as ŷ₁.
Determining whether a sample of the quantized latent ŷ(or ŵ) is to be decoded from a bitstream or inferred according to σ.
If the sample is determined to be decoded, setting the value of the sample equal to ŷ₁, otherwise inferring the value of the sample.

Obtaining a reconstructed image using the quantized latent ŷ(or ŵ).

2. Encoder embodiment:

An image or video encoding method, comprising the steps of:
First transforming an input image using an analysis transform to obtain samples of quantized latent ŷ (or ŵ).
Obtaining a statistical parameter σ using an estimation module.
Determining whether a sample of the quantized latent ŷ (or ŵ) is to be encoded in a bitstream or not according to σ.

Including the value of the sample of ŷ(or ŵ) if it is determined to be encoded, into a bitstream by an entropy coder according to statistical parameter σ. Not including the value of the sample if it is determined not to be encoded.

3. According to embodiments 1 and 2,

The estimation module comprises a neural subnetwork.

4. According to all embodiments above,

The estimation module receives a bitstream as input, processes the input with the neural subnetwork and outputs the statistical parameters.

5. According to embodiment 1,

Determining whether a sample of the quantized latent ŷ(or ŵ) is to be decoded (or encoded) comprises comparing at least one statistical parameter (or a function thereof), which may be associated with at least one threshold value.

6. According to all embodiments above,

The statistical parameter is a variance parameter.

7. According to embodiment 5 and 6,

Including the value of the threshold (or an indication thereof) in the bitstream.

8. According to all embodiments above,

The variance parameter is a variance of a probability distribution (e.g. a gaussian probability distribution or a Laplacian probability distribution).

9. According to all embodiments above,

Determining whether a sample of the quantized latent y (or @) is to be decoded (or encoded) comprises at least one step of the steps:
Obtaining a probability using the statistical parameter, and
Comparing the probability with a threshold.

10. According to all embodiments above,

Determining whether a sample of the quantized latent y (or w) is to be decoded (or encoded) comprises at least one step of the steps:
Obtaining probabilities corresponding to samples of the quantized latent using the statistical parameter,
Grouping the samples of the quantized latent into blocks of size N by M,
Checking if probability of all of the samples comprised in a block are smaller than a threshold.
Determining that the samples of the block are to be decoded (or encoded) if the outcome of the checking is true.

11. According to all embodiments above,

Determining whether a sample of the quantized latent y (or w) is to be decoded (or encoded) comprises at least one step of the steps:
Obtaining probabilities corresponding to samples of the quantized latent using the variance parameter,
Grouping the samples of the quantized latent into blocks of size N by M,
Checking if the average of the probabilities of all of the samples comprised in a block are smaller than a threshold.
Determining that the samples of the block are to be decoded (or encoded) if the outcome of the checking is true.

12. According to all embodiments 11,

The obtained probability is probability of a quantized sample being equal to zero.

13. According to all embodiments above,

Determining whether a sample of the quantized latent ŷ(or ŵ) is to be decoded (or encoded) comprises at least one step of the steps:
Grouping the samples of the quantized latent into blocks of size N by M,
Checking if the variance values corresponding to all of the samples comprised in a block are smaller than a threshold.
Determining that the samples of the block are to be decoded (or encoded) if the outcome of the checking is true.

14. According to all embodiments above,

Determining whether a sample of the quantized latent ŷ(or ŵ) is to be decoded (or encoded) comprises at least one step of the steps:
Grouping the samples of the quantized latent into blocks of size N by M,
Checking if the average variance of all of the samples comprised in a block are smaller than a threshold.
Determining that the samples of the block are to be decoded (or encoded) if the outcome of the checking is true.

15. According to all embodiments above,

If a sample is determined not to be decoded from the bitstream, its value is inferred to be equal to a predetermined value.

16. According to all embodiments above,

If a sample is determined not to be decoded from the bitstream, its value is inferred to be equal to a mean value.

17. According to embodiment 16,

The mean value is obtained by the estimation module.

18. According to all embodiments above,

The probability of a sample is the probability that the value of the sample is equal to zero.

19. According to all embodiments above,

The probability of a sample is the probability that the value of the sample is equal to a mean value that is estimated by the estimation module.

20. According to embodiments 10 to 14,

Wherein the M and N can be positive integers.

21. According to embodiments 10 to 14 and 19,

Wherein the M and N can be signalled in the bitstream.

22. According to any of the embodiments above, including the value of at least one piece of control information, which can determine whether to and/or how to apply any methods mentioned above.

23. Whether to and/or how to apply any methods mentioned above may depend on a condition, such as the colour format and/or colour component.

24. According to any of the embodiments above, any value included in the bitstream may be coded at sequence/picture/slice/block level.

25. According to any of the embodiments above, any value included in the bitstream may be binarized before being coded.

26. According to any of the embodiments above, any value included in the bitstream may be coded with at least one arithmetic coding context.

More details of the embodiments of the present disclosure will be described below which are related to neural network-based visual data coding. As used herein, the term “visual data” may refer to an image, a picture in a video, or any other visual data suitable to be coded.

As discussed above, in the existing architectures, most of the modules are massively parallelizable, hence these processes can be accelerated considerably by a GPU. On the other hand, the process of entropy coding (encoding or decoding) consists of conversion between input samples and a sequence of bits (i.e. the bitstream), and therefore it is inherently a sequential process. Due to its sequential nature, entropy coding is not parallelizable, therefore it is the bottleneck process and slows down the entire coding process.

To solve the above problems and some other problems not mentioned, visual data processing solutions as described below are disclosed.

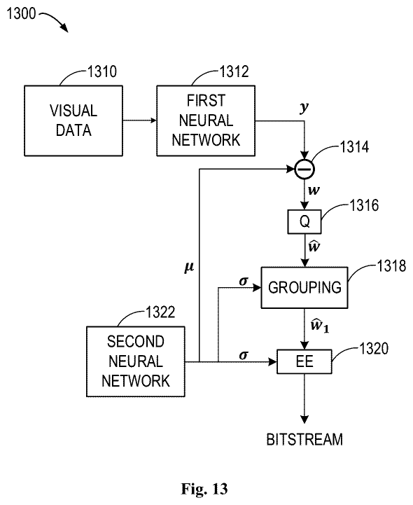

FIG. 13 illustrates an example visual data encoding process 1300 according to some embodiments of the present disclosure. For example, the visual data encoding process 1300 may be performed by the visual data encoder 114 as shown in FIG. 1. It should be understood that the visual data encoding process 1300 may also include additional blocks not shown, and/or blocks shown may be omitted. The scope of the present disclosure is not limited in this respect.

As shown in FIG. 13, at the first neural network 1312, an analysis transform may be performed on the visual data 1310 to obtain a latent representation (denoted as y in FIG. 13) of the visual data 1310. The visual data 1310 may comprises an image or one or more pictures in a video. At the block 1314, a statistical value may be subtracted from the latent representation, so as to obtain a residual latent representation (denoted as w in FIG. 13). The statistical value may be generated by the second neural network 1322 and indicate a prediction of the latent representation. By way of example rather than limitation, the statistical value may be a mean (denoted as u in FIG. 13) of a probability distribution, such as a gaussian probability distribution. For example, the probability distribution may describe a probability distribution of the value of one or more samples of the latent representation. It should be understood that a statistical value may also be referred to as a statistical parameter, a probability parameter, a probability distribution parameter, or the like. The scope of the present disclosure is not limited in this respect.

The statistical value may be comprised in statistical information generated by a second neural network 1322. For example, the second neural network 1322 may be referred to as an estimation model. It should be noted that a model may also be referred to as a module in the present application. That is, the second neural network may also be referred to as a first module, and the estimation model may also be referred to as an estimation module. The input of the second neural network 1322 may comprise the latent representation, and the output of the second neural network 1322 comprise the statistical information. In one example, the second neural network 1322 may comprise a neural network-based subnetwork. In another example, the second neural network 1322 may comprise a first subnetwork for generating the statistical value and a second subnetwork for generating a further statistical value. By way of example rather than limitation, the further statistical value may be a variance (denoted as σ in FIG. 13) of a probability distribution, such as a gaussian probability distribution. For example, the probability distribution may describe a probability distribution of the value of one or more samples of the latent representation. The first subnetwork may be a hyper decoder subnetwork, and the second subnetwork may be a hyper scale decoder subnetwork. In an example, the second neural network 1322 may further comprise a hyper encoder subnetwork. It should be understood that the above mentioned mean and variance are just two specific examples of statistical values which may be used. Any other suitable statistical values, such as a standard deviation, may also be used. The scope of the present disclosure is not limited in this respect.

At quantizing block 1316, the residual latent representation may be quantized to obtain a quantized residual latent representation. The quantized residual latent representation may also be referred to as a quantization of the residual latent representation. In one example, the residual latent representation may be quantized by using a rounding function. In another example, the residual latent representation may be quantized by using a floor function. Alternatively, the residual latent representation may be quantized by using a ceiling function. It should be understood that the above examples are described merely for purpose of description. The scope of the present disclosure is not limited in this respect.

At grouping block 1318, at least one sample may be determined from a quantization of the representation based on the statistical information. The at least one sample constitute a group of samples whose value will not be encoded into the bitstream. Thus, the process for determining the at least one sample may also be referred to as a grouping process, during which at least one set of samples may be obtained. In one example, this grouping process may be performed at a sample-level. In other words, the determination of the at least one sample is made for each of the samples of the quantized residual latent representation. Alternatively, the grouping process may be performed at a block-level. More specifically, the samples of the quantized residual latent representation may be divided into a plurality of blocks. Each of the plurality of blocks may have a predetermined size of N by M, such as 8×8. Each of N and M is a positive integer. N and M may be indicated in the bitstream. The samples may be grouped based on the plurality of blocks. In other words, the determination of the at least one sample is made for each of the plurality of blocks, and samples in the same block are divided into the same set.

In some embodiments, for a sample of the quantization, if a first statistical value corresponding to the sample is smaller than a first threshold, it may be determined that the at least one sample comprises the sample, and the sample may be grouped into a second set. Otherwise, it may be determined that the sample will not be comprised into the at least one sample, and the sample may be grouped into a first set different from the second set. In one example, the first statistical value may be the above-mentioned variance.

Alternatively, for a sample of the quantization, if a first statistical value corresponding to the sample is larger than a further threshold which may be the same as or different from the first threshold, it may be determined that the at least one sample comprises the sample, and the sample may be grouped into the second set. Otherwise, it may be determined that the sample will not be comprised into the at least one sample, and the sample may be grouped into the first set. The above-mentioned comparison may be performed for each of the samples of the quantized residual latent representation, so as to obtain the at least one sample.

It should be understood that the at least one sample may be determined in any other suitable manner, such as, based on a comparison between a value determined based on the first statistical value and a threshold, or a comparison between a threshold and a probability that a value of the sample is equal to a target value. The probability may be determined based on the statistical information. The target value of a sample may be a first predetermined value (such as zero), or a second statistical value (such as a mean) corresponding to the sample. This is described in detail at the above section 4.3.

In some alternative embodiments, the grouping process may be performed at a block-level. In such a case, for samples in a block of the quantization, if a first statistical value corresponding to each sample in the block is smaller than a fourth threshold, it may be determined that the at least one sample comprises all of samples in the block, and these samples may be grouped into a second set. Otherwise, it may be determined that these samples will not be comprised into the at least one sample, and these samples may be grouped into a first set different from the second set. In one example, the first statistical value may be the above-mentioned variance.

Alternatively, for samples in a block of the quantization, if a first statistical value corresponding to each sample in the block is larger than a further threshold which may be the same as or different from the fourth threshold, it may be determined that the at least one sample comprises all of samples in the block, and these samples may be grouped into a second set. Otherwise, it may be determined that these samples will not be comprised into the at least one sample, and these samples may be grouped into a first set. The above-mentioned comparison may be performed for each of the blocks of the quantized residual latent representation, so as to obtain the at least one sample.

It should be understood that the at least one sample may be determined in any other suitable manner, such as, based on a comparison between a threshold and a first metric determined based on first statistical values corresponding to samples in the block, or a comparison between a threshold and a probability that a value of each sample in the block is equal to a target value, or a comparison between a threshold and a second metric determined based on probabilities that values of samples in the block are equal to respective target values. By way of example rather than limitation, the first metric may be an average, a minimum one or a maximum one of the first statistical values. The second metric may be an average, a minimum one or a maximum one of the probabilities. At least one of the thresholds used may be indicated in the bitstream.

In some embodiments, the output of the grouping block 1318 may comprise the rest of samples of the quantized residual latent representation other than the at least one sample. For example, the output of the grouping block 1318 may comprise the above-mentioned first set of samples (denoted as Ŵ₁ in FIG. 13) different from the at least one sample. At the entropy encoder 1320, an entropy encoding process may be performed on the first set of samples based on the statistical information generated by the second neural network. Although only the variance is used for the entropy encoding process in the example shown in FIG. 13, any other suitable statistical value(s), such as a mean and/or a standard deviation, may be used. The entropy encoding process performed by the entropy encoder 1320 may be an arithmetic encoding process, a Huffman encoding process, or the like.

In addition, the statistical information generated by the second neural network may also be encoded into the bitstream by performing an entropy encoding process on the statistical information, which is not shown in FIG. 13.

In a special case, the at least one sample may comprise all samples of the quantized residual latent representation. In such a case, values of all samples of the quantized residual latent representation will not be encoded into the bitstream, while the statistical information is signaled in the bitstream.

In view of the above, a value of at least one sample of a quantization of the representation of the visual data is not comprised in the bitstream. Thereby, it is possible to skip at least a part of the quantization during the entropy coding process, so as to reduce the time spent for entropy coding. As such, the proposed method can advantageously improve the coding speed and the coding efficiency.

Although an example visual data encoding process is described above with respect to FIG. 13, it should be understood that any other suitable variants of the visual data encoding process are also conceivable in view of the present disclosure. In another example, the latent representation rather than the residual latent representation may be adjusted, which is shown illustratively in the left sub-figure of FIG. 10.

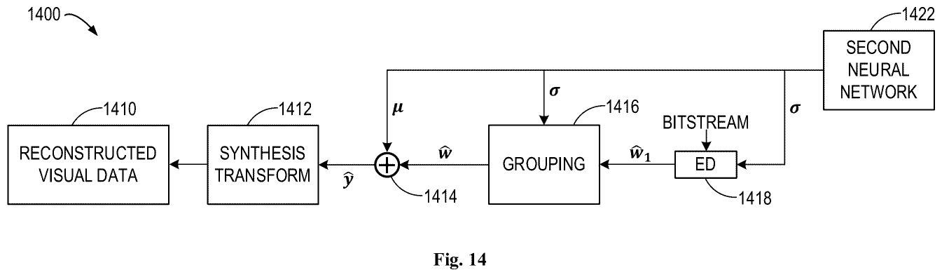

FIG. 14 illustrates an example visual data decoding process 1400 according to some embodiments of the present disclosure. For example, the visual data decoding process 1400 may be performed by the visual data decoder 124 as shown in FIG. 1. It should be understood that the visual data decoding process 1400 may also include additional blocks not shown, and/or blocks shown may be omitted. The scope of the present disclosure is not limited in this respect.

As shown in FIG. 14, statistical information may be generated by the second neural network 1422. The statistical information may comprise the mean μ and/or the variance σ. For example, the second neural network 1422 may be referred to as an estimation model. The input of the second neural network 1422 may comprise the bitstream, and the output of the second neural network 1422 comprise the at least one statistical value. In one example, the second neural network 1422 may comprise a neural network-based subnetwork. In another example, the second neural network 1422 may comprise a first subnetwork for generating a first statistical value and a second subnetwork for generating a second statistical value. In one example, the first statistical value may be a variance of a gaussian probability distribution, and the second statistical value may be a mean of the gaussian probability distribution. The first subnetwork may be a hyper scale decoder subnetwork, and the second subnetwork may be a hyper decoder subnetwork. It should be understood that the above mentioned mean and variance are just two specific examples of statistical values which may be used. Any other suitable statistical values, such as a standard deviation, may also be used. The scope of the present disclosure is not limited in this respect.

At the entropy decoder 1418, an entropy decoding process may be performed on the bitstream based on the statistical information, so as to obtain values of the first set of samples of the quantized residual latent representation (denoted as ŵ₁ in FIG. 14).

At grouping block 1416, at least one sample may be determined from a quantization of the residual latent representation based on the statistical information in a similar manner to the grouping process described with regard to the grouping block 1318 in FIG. 13, and thus this will not be described in detail for conciseness.

Since a value of the at least one sample is not signaled in the bitstream, the value of each of the at least one sample may be inferred. In one example, the value of each of the at least one sample may be determined to be a predetermined value. This predetermined value may be a constant scalar number, such as zero. Alternatively, the value of each of the at least one sample may be determined to be a third statistical value (such as a mean) corresponding to the sample. It should be understood that the value of each of the at least one sample may be inferred in any other suitable manner. The scope of the present disclosure is not limited in this respect. The quantized residual latent representation may be reconstructed at the grouping block 1416 based on the obtained values of the first set of samples and the inferred values of the at least one sample. In the above-mentioned special case, the quantized residual latent representation may be reconstructed at the grouping block 1416 based on the inferred values of the at least one sample.

At block 1414, the quantized latent representation (denoted as ŷ in FIG. 14) may be obtained by adding a statistical value (e.g., a mean μ in FIG. 14) and the output of the grouping block 1416, i.e., the quantized residual latent representation. At the synthesis transform subnetwork 1412, a synthesis transform may be performed on the quantized latent representation to obtain the reconstructed visual data 1410.

In view of the above, a value of at least one sample of a quantization of the representation of the visual data is not comprised in the bitstream. Thereby, the proposed method makes it possible to skip at least a part of the quantization during the entropy coding process, so as to reduce the time spent for entropy coding. As such, the proposed method can advantageously improve the coding speed and the coding efficiency.

Although an example visual data decoding process is described above with respect to FIG. 14, it should be understood that any other suitable variants of the visual data decoding process are also conceivable in view of the present disclosure. In another example, the latent representation rather than the residual latent representation may be used, which is shown illustratively in the bottom sub-figure of FIG. 11.

It should be understood that the above illustrations and/or examples are described merely for purpose of description. The scope of the present disclosure is not limited in this respect. The embodiments of the present disclosure should be considered as examples to explain the general concepts and should not be interpreted in a narrow way. Furthermore, these embodiments can be applied individually or combined in any manner.

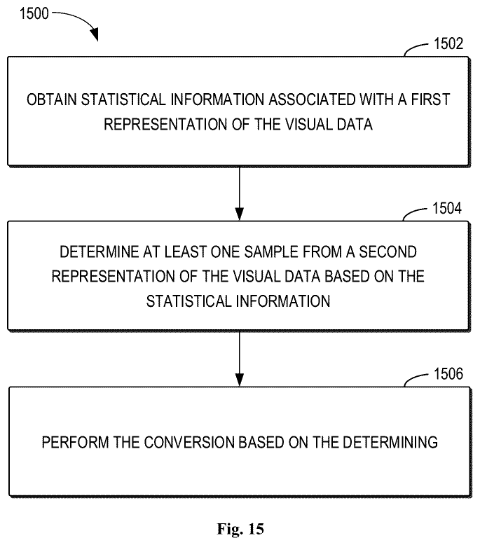

FIG. 15 illustrates a flowchart of a method 1500 for visual data processing in accordance with some embodiments of the present disclosure. The method 1500 may be implemented during a conversion between the visual data and a bitstream of the visual data. As shown in FIG. 15, the method 1500 starts at 1502, where statistical information associated with a first representation of the visual data is obtained. The first representation is generated based on applying a first neural network to the visual data. In one example, the first neural network may be used to perform an analysis transform on the visual data. In some embodiments, the first representation may be a latent representation of the visual data or a residual latent presentation of the visual data.

At 1504, at least one sample is determined from a second representation of the visual data based on the statistical information. A value of the at least one sample is absent from the bitstream. The second representation is obtained by quantizing the first representation.

At 1506, the conversion is performed based on the determining. In one example, the conversion may include encoding the visual data into the bitstream. Alternatively or additionally, the conversion may include decoding the visual data from the bitstream. It should be understood that the above illustrations are described merely for purpose of description. The scope of the present disclosure is not limited in this respect.

In view of the foregoing, a value of at least one sample of a second representation of the first representation of the visual data is not comprised in the bitstream. Thereby, the proposed method makes it possible to skip at least a part of the second representation during the entropy coding process, so as to reduce the time spent for entropy coding. As such, the proposed method can advantageously improve the coding speed and the coding efficiency.

In some embodiments, at 1504, a determination is made that the at least one sample comprises a sample of the second representation, if at least one of the following conditions is satisfied: a first statistical value corresponding to the sample is smaller than a first threshold, a value determined based on the first statistical value is smaller than a second threshold, or a probability that a value of the sample is equal to a target value is smaller than a third threshold.

In some embodiments, at 1504, a determination is made that the at least one sample comprises samples in a block of the second representation, if at least one of the following conditions is satisfied: a first statistical value corresponding to each sample in the block is smaller than a fourth threshold; a first metric is smaller than a fifth threshold, the first metric may be determined based on first statistical values corresponding to samples in the block; a probability that a value of each sample in the block is equal to a target value is smaller than a sixth threshold; or a second metric is smaller than a seventh threshold, the second metric may be determined based on probabilities that values of samples in the block are equal to respective target values.

In some embodiments, at 1504, a determination is made that the at least one sample comprises a sample of the second representation, if at least one of the following conditions is satisfied: a first statistical value corresponding to the sample is larger than an eighth threshold, a value determined based on the first statistical value is larger than a ninth threshold, or a probability that a value of the sample is equal to a target value is larger than a tenth threshold.

In some embodiments, at 1504, a determination is made that the at least one sample comprises samples in a block of the second representation, if at least one of the following conditions is satisfied: a first statistical value corresponding to each sample in the block is larger than an eleventh threshold; a first metric is larger than a twelfth threshold, the first metric may be determined based on first statistical values corresponding to samples in the block; a probability that a value of each sample in the block is equal to a target value is larger than a thirteenth threshold; or a second metric is larger than a fourteenth threshold, the second metric may be determined based on probabilities that values of samples in the block are equal to respective target values.

In some embodiments, the first metric may be an average, a minimum one or a maximum one of the first statistical values. Additionally or alternatively, the second metric may be an average, a minimum one or a maximum one of the probabilities.

In some embodiments, a size of the block may be N by M, and each of N and M may be a positive integer. In one example, N and M may be indicated in the bitstream. In some embodiments, the first statistical value may be a variance. In some embodiments, a target value of a sample may comprise one of the following: a first predetermined value, or a second statistical value corresponding to the sample. In one example, the first predetermined value may be zero, or the second statistical value may be a mean. In some embodiments, the probability may be determined based on the statistical information.

In some embodiments, at least one of the following thresholds may be indicated in the bitstream: the first threshold, the second threshold, the third threshold, the fourth threshold, the fifth threshold, the sixth threshold, the seventh threshold, the eighth threshold, the ninth threshold, the tenth threshold, the eleventh threshold, the twelfth threshold, the thirteenth threshold, or the fourteenth threshold.

In some embodiments, at 1506, the second representation may be reconstructed based on the at least one sample. Furthermore, the conversion may be performed based on the reconstructed second representation.

In some embodiments, the at least one sample may comprise all samples of the second representation. In such a case, values of the at least one sample may be determined to reconstruct the second representation.

In some embodiments, the second representation may comprise the at least one sample and a first set of samples different from the at least one sample. Values of the at least one sample may be determined. Values of the first set of samples may be obtained by performing entropy decoding process on the bitstream based on the statistical information. The second representation may be reconstructed based on the values of the first set of samples and the determined values of the at least one sample.

In some embodiments, for determining values of the at least one sample, a value of each sample of the at least one sample may be determined to be a second predetermined value or a third statistical value corresponding to the sample. In one example, the second predetermined value may be a constant scalar number, such as zero. For example, the third statistical value may be a mean.

In some embodiments, the first representation may be a latent representation of the visual data. At 1506, the visual data may be reconstructed by performing a synthesis transform on the reconstructed second representation.

In some embodiments, the first representation may be a residual latent representation of the visual data. At 1506, a quantized latent representation of the visual data may be generated based on the reconstructed second representation and a fourth statistical value comprised in the statistical information. The visual data may be reconstructed by performing a synthesis transform on the quantized latent representation.

In some embodiments, the at least one sample may comprise all samples of the second representation. At 1506, the bitstream may be generated by performing an entropy encoding process on the statistical information.

In some embodiments, the second representation may comprise the at least one sample and a first set of samples different from the at least one sample. At 1506, a first part of the bitstream may be generated by performing an entropy encoding process on the statistical information. A second part of the bitstream may be generated by performing an entropy encoding process on the first set of samples based on the statistical information.

In some embodiments, the first representation may be a latent representation of the visual data. The method may further comprise: generating the latent representation by performing an analysis transform on the visual data by using the first neural network; and obtaining the second representation by quantizing the latent representation.

In some embodiments, the first representation may be a residual latent representation of the visual data. The method may further comprise: generating a latent representation of the visual data by performing an analysis transform on the visual data by using the first neural network; generating the residual latent representation based on the latent representation and a fourth statistical value comprised in the statistical information by using the first neural network; and obtaining the second representation by quantizing the residual latent representation. In some embodiments, the fourth statistical value may be a mean.

In some embodiments, the statistical information may be generated by using a second neural network. In one example, the second neural network may be an estimation model. The second neural network may comprise a neural network-based subnetwork. An input of the second neural network may comprise the bitstream or a latent representation of the visual data.

In some embodiments, the statistical information may comprise a first statistical value and a second statistical value. The second neural network may comprise a first subnetwork for generating the first statistical value and a second subnetwork for generating the second statistical value. The first statistical value may be a variance, and the second statistical value may be a mean.

In some embodiments, the first statistical value may be a variance of a gaussian probability distribution, and the second statistical value may be a mean of the gaussian probability distribution. Additionally or alternatively, the first subnetwork may be a hyper scale decoder subnetwork, and the second subnetwork may be a hyper decoder subnetwork.

In some embodiments, at least one of the following may be indicated the bitstream: information on whether to apply the method, or information on how to apply the method. In some embodiments, at least one of the following may be dependent on a color format and/or a color component of the visual data: information on whether to apply the method, or information on how to apply the method.

In some embodiments, a value included in the bitstream may be coded at one of the following: a sequence level, a picture level, a slice level, or a block level. In some embodiments, a value included in the bitstream may be binarized before may be coded. In some embodiments, a value included in the bitstream may be coded with at least one arithmetic coding context.

According to further embodiments of the present disclosure, a non-transitory computer-readable recording medium is provided. The non-transitory computer-readable recording medium stores a bitstream of visual data which is generated by a method performed by an apparatus for visual data processing. The method comprises: obtaining, for a conversion between visual data and a bitstream of the visual data, statistical information associated with a first representation of the visual data, the first representation being generated based on applying a first neural network to the visual data; determining at least one sample from a second representation of the visual data based on the statistical information, a value of the at least one sample being absent from the bitstream, the second representation being obtained by quantizing the first representation; and generating the bitstream based on the determining.

According to still further embodiments of the present disclosure, a method for storing a bitstream of visual data is provided. The method comprises: obtaining, for a conversion between visual data and a bitstream of the visual data, statistical information associated with a first representation of the visual data, the first representation being generated based on applying a first neural network to the visual data; determining at least one sample from a second representation of the visual data based on the statistical information, a value of the at least one sample being absent from the bitstream, the second representation being obtained by quantizing the first representation; generating the bitstream based on the determining; and storing the bitstream in a non-transitory computer-readable recording medium.

Implementations of the present disclosure can be described in view of the following clauses, the features of which can be combined in any reasonable manner.

Clause 1. A method for visual data processing, comprising: obtaining, for a conversion between visual data and a bitstream of the visual data, statistical information associated with a first representation of the visual data, the first representation being generated based on applying a first neural network to the visual data; determining at least one sample from a second representation of the visual data based on the statistical information, a value of the at least one sample being absent from the bitstream, the second representation being obtained by quantizing the first representation; and performing the conversion based on the determining.

Clause 2. The method of clause 1, wherein the first representation comprises a latent representation of the visual data or a residual latent presentation of the visual data.

Clause 3. The method of any of clauses 1-2, wherein determining the at least one sample from the second representation comprises: determining the at least one sample comprises a sample of the second representation in accordance with a determination that at least one of the following conditions is satisfied: a first statistical value corresponding to the sample is smaller than a first threshold, a value determined based on the first statistical value is smaller than a second threshold, or a probability that a value of the sample is equal to a target value is smaller than a third threshold.

Clause 4. The method of any of clauses 1-2, wherein determining the at least one sample from the second representation comprises: determining the at least one sample comprises samples in a block of the second representation in accordance with a determination that at least one of the following conditions is satisfied: a first statistical value corresponding to each sample in the block is smaller than a fourth threshold, a first metric is smaller than a fifth threshold, the first metric being determined based on first statistical values corresponding to samples in the block, a probability that a value of each sample in the block is equal to a target value is smaller than a sixth threshold, or a second metric is smaller than a seventh threshold, the second metric being determined based on probabilities that values of samples in the block are equal to respective target values.

Clause 5. The method of any of clauses 1-2, wherein determining the at least one sample from the second representation comprises: determining the at least one sample comprises a sample of the second representation in accordance with a determination that at least one of the following conditions is satisfied: a first statistical value corresponding to the sample is larger than an eighth threshold, a value determined based on the first statistical value is larger than a ninth threshold, or a probability that a value of the sample is equal to a target value is larger than a tenth threshold.

Clause 6. The method of any of clauses 1-2, wherein determining the at least one sample from the second representation comprises: determining the at least one sample comprises samples in a block of the second representation in accordance with a determination that at least one of the following conditions is satisfied: a first statistical value corresponding to each sample in the block is larger than an eleventh threshold, a first metric is larger than a twelfth threshold, the first metric being determined based on first statistical values corresponding to samples in the block, a probability that a value of each sample in the block is equal to a target value is larger than a thirteenth threshold, or a second metric is larger than a fourteenth threshold, the second metric being determined based on probabilities that values of samples in the block are equal to respective target values.

Clause 7. The method of clause 4 or 6, wherein the first metric is an average, a minimum one or a maximum one of the first statistical values, or the second metric is an average, a minimum one or a maximum one of the probabilities.

Clause 8. The method of any of clauses 4 and 7-8, wherein a size of the block is N by M, and each of N and M is a positive integer.

Clause 9. The method of clause 8, wherein N and M are indicated in the bitstream.

Clause 10. The method of any of clauses 3-9, wherein the first statistical value is a variance.

Clause 11. The method of any of clauses 3-10, wherein a target value of a sample comprises one of the following: a first predetermined value, or a second statistical value corresponding to the sample.

Clause 12. The method of clause 11, wherein the first predetermined value is zero, or the second statistical value is a mean.

Clause 13. The method of any of clauses 3-12, wherein the probability is determined based on the statistical information.

Clause 14. The method of any of clauses 3-13, wherein at least one of the following thresholds is indicated in the bitstream: the first threshold, the second threshold, the third threshold, the fourth threshold, the fifth threshold, the sixth threshold, the seventh threshold, the eighth threshold, the ninth threshold, the tenth threshold, the eleventh threshold, the twelfth threshold, the thirteenth threshold, or the fourteenth threshold.

Clause 15. The method of any of clauses 1-14, wherein performing the conversion comprises: reconstructing the second representation based on the at least one sample; and performing the conversion based on the reconstructed second representation.

Clause 16. The method of clause 15, wherein the at least one sample comprises all samples of the second representation, and reconstructing the second representation comprises: determining values of the at least one sample to reconstruct the second representation.

Clause 17. The method of clause 15, wherein the second representation comprises the at least one sample and a first set of samples different from the at least one sample, and reconstructing the second representation comprises: determining values of the at least one sample; obtaining values of the first set of samples by performing entropy decoding process on the bitstream based on the statistical information; and reconstructing the second representation based on the values of the first set of samples and the determined values of the at least one sample.

Clause 18. The method of any of clauses 16-17, wherein determining values of the at least one sample comprises: determining a value of each sample of the at least one sample to be a second predetermined value or a third statistical value corresponding to the sample.

Clause 19. The method of clause 18, wherein the second predetermined value is a constant scalar number.

Clause 20. The method of clause 18, wherein the second predetermined value is zero.

Clause 21. The method of any of clauses 18-20, wherein the third statistical value is a mean.

Clause 22. The method of any of clauses 15-21, wherein the first representation is a latent representation of the visual data, and performing the conversion based on the reconstructed second representation comprises: reconstructing the visual data by performing a synthesis transform on the reconstructed second representation.

Clause 23. The method of any of clauses 15-21, wherein the first representation is a residual latent representation of the visual data, and performing the conversion comprises: generating a quantized latent representation of the visual data based on the reconstructed second representation and a fourth statistical value comprised in the statistical information; and reconstructing the visual data by performing a synthesis transform on the quantized latent representation.

Clause 24. The method of any of clauses 1-14, wherein the at least one sample comprises all samples of the second representation, and performing the conversion comprises: generating the bitstream by performing an entropy encoding process on the statistical information.

Clause 25. The method of any of clauses 1-14, wherein the second representation comprises the at least one sample and a first set of samples different from the at least one sample, and performing the conversion comprises: generating a first part of the bitstream by performing an entropy encoding process on the statistical information; and generating a second part of the bitstream by performing an entropy encoding process on the first set of samples based on the statistical information.

Clause 26. The method of any of clauses 24-25, wherein the first representation is a latent representation of the visual data, and the method further comprises: generating the latent representation by performing an analysis transform on the visual data by using the first neural network; and obtaining the second representation by quantizing the latent representation.

Clause 27. The method of any of clauses 24-25, wherein the first representation is a residual latent representation of the visual data, and the method further comprises: generating a latent representation of the visual data by performing an analysis transform on the visual data by using the first neural network; generating the residual latent representation based on the latent representation and a fourth statistical value comprised in the statistical information; and obtaining the second representation by quantizing the residual latent representation.

Clause 28. The method of clause 23 or 28, wherein the fourth statistical value is a mean.

Clause 29. The method of any of clauses 1-28, wherein the statistical information is generated by using a second neural network.

Clause 30. The method of clause 29, wherein the second neural network is an estimation model.

Clause 31. The method of any of clauses 29-30, wherein the second neural network comprises a neural network-based subnetwork.

Clause 32. The method of any of clauses 29-31, wherein an input of the second neural network comprises the bitstream or a latent representation of the visual data.

Clause 33. The method of any of clauses 29-30, wherein the statistical information comprises a first statistical value and a second statistical value, and the second neural network comprises a first subnetwork for generating the first statistical value and a second subnetwork for generating the second statistical value.

Clause 34. The method of clause 33, wherein the first statistical value is a variance, and the second statistical value is a mean.

Clause 35. The method of clause 33, wherein the first statistical value is a variance of a gaussian probability distribution, and the second statistical value is a mean of the gaussian probability distribution.

Clause 36. The method of any of clauses 33-35, wherein the first subnetwork is a hyper scale decoder subnetwork, and the second subnetwork is a hyper decoder subnetwork.

Clause 37. The method of any of clauses 1-36, wherein at least one of the following is indicated the bitstream: information on whether to apply the method, or information on how to apply the method.

Clause 38. The method of any of clauses 1-36, wherein at least one of the following is dependent on a color format and/or a color component of the visual data: information on whether to apply the method, or information on how to apply the method.

Clause 39. The method of any of clauses 1-38, wherein a value included in the bitstream is coded at one of the following: a sequence level, a picture level, a slice level, or a block level.

Clause 40. The method of any of clauses 1-39, wherein a value included in the bitstream is binarized before being coded.

Clause 41. The method of any of clauses 1-40, wherein a value included in the bitstream is coded with at least one arithmetic coding context.

Clause 42. The method of any of clauses 1-41, wherein the visual data comprise a picture of a video or an image.

Clause 43. The method of any of clauses 1-42, wherein the conversion includes encoding the visual data into the bitstream.

Clause 44. The method of any of clauses 1-42, wherein the conversion includes

decoding the visual data from the bitstream.

Clause 45. An apparatus for visual data processing comprising a processor and a non-transitory memory with instructions thereon, wherein the instructions upon execution by the processor, cause the processor to perform a method in accordance with any of clauses 1-44.

Clause 46. A non-transitory computer-readable storage medium storing instructions that cause a processor to perform a method in accordance with any of clauses 1-44.

Clause 47. A non-transitory computer-readable recording medium storing a bitstream of visual data which is generated by a method performed by an apparatus for visual data processing, wherein the method comprises: obtaining, for a conversion between visual data and a bitstream of the visual data, statistical information associated with a first representation of the visual data, the first representation being generated based on applying a first neural network to the visual data; determining at least one sample from a second representation of the visual data based on the statistical information, a value of the at least one sample being absent from the bitstream, the second representation being obtained by quantizing the first representation; and generating the bitstream based on the determining.

Clause 48. A method for storing a bitstream of visual data, comprising: obtaining, for a conversion between visual data and a bitstream of the visual data, statistical information associated with a first representation of the visual data, the first representation being generated based on applying a first neural network to the visual data; determining at least one sample from a second representation of the visual data based on the statistical information, a value of the at least one sample being absent from the bitstream, the second representation being obtained by quantizing the first representation; generating the bitstream based on the determining; and storing the bitstream in a non-transitory computer-readable recording medium.

### Example Device

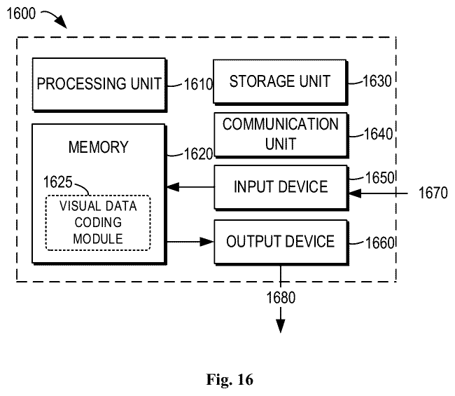

FIG. 16 illustrates a block diagram of a computing device 1600 in which various embodiments of the present disclosure can be implemented. The computing device 1600 may be implemented as or included in the source device 110 (or the visual data encoder 114) or the destination device 120 (or the visual data decoder 124).

It would be appreciated that the computing device 1600 shown in FIG. 16 is merely for purpose of illustration, without suggesting any limitation to the functions and scopes of the embodiments of the present disclosure in any manner.

As shown in FIG. 16, the computing device 1600 includes a general-purpose computing device 1600. The computing device 1600 may at least comprise one or more processors or processing units 1610, a memory 1620, a storage unit 1630, one or more communication units 1640, one or more input devices 1650, and one or more output devices 1660.

In some embodiments, the computing device 1600 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1600 can support any type of interface to a user (such as “wearable” circuitry and the like).

The processing unit 1610 may be a physical or virtual processor and can implement various processes based on programs stored in the memory 1620. In a multi-processor system, multiple processing units execute computer executable instructions in parallel so as to improve the parallel processing capability of the computing device 1600. The processing unit 1610 may also be referred to as a central processing unit (CPU), a microprocessor, a controller or a microcontroller.

The computing device 1600 typically includes various computer storage medium. Such medium can be any medium accessible by the computing device 1600, including, but not limited to, volatile and non-volatile medium, or detachable and non-detachable medium. The memory 1620 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1630 may be any detachable or non-detachable medium and may include a machine-readable medium such as a memory, flash memory drive, magnetic disk or another other media, which can be used for storing information and/or data and can be accessed in the computing device 1600.

The computing device 1600 may further include additional detachable/non-detachable, volatile/non-volatile memory medium. Although not shown in FIG. 16, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1640 communicates with a further computing device via the communication medium. In addition, the functions of the components in the computing device 1600 can be implemented by a single computing cluster or multiple computing machines that can communicate via communication connections. Therefore, the computing device 1600 can operate in a networked environment using a logical connection with one or more other servers, networked personal computers (PCs) or further general network nodes.

The input device 1650 may be one or more of a variety of input devices, such as a mouse, keyboard, tracking ball, voice-input device, and the like. The output device 1660 may be one or more of a variety of output devices, such as a display, loudspeaker, printer, and the like. By means of the communication unit 1640, the computing device 1600 can further communicate with one or more external devices (not shown) such as the storage devices and display device, with one or more devices enabling the user to interact with the computing device 1600, or any devices (such as a network card, a modem and the like) enabling the computing device 1600 to communicate with one or more other computing devices, if required. Such communication can be performed via input/output (I/O) interfaces (not shown).

In some embodiments, instead of being integrated in a single device, some or all components of the computing device 1600 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1600 may be used to implement visual data encoding/decoding in embodiments of the present disclosure. The memory 1620 may include one or more visual data coding modules 1625 having one or more program instructions. These modules are accessible and executable by the processing unit 1610 to perform the functionalities of the various embodiments described herein.

In the example embodiments of performing visual data encoding, the input device 1650 may receive visual data as an input 1670 to be encoded. The visual data may be processed, for example, by the visual data coding module 1625, to generate an encoded bitstream. The encoded bitstream may be provided via the output device 1660 as an output 1680.

In the example embodiments of performing visual data decoding, the input device 1650 may receive an encoded bitstream as the input 1670. The encoded bitstream may be processed, for example, by the visual data coding module 1625, to generate decoded visual data. The decoded visual data may be provided via the output device 1660 as the output 1680.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for visual data processing, comprising:
obtaining, for a conversion between visual data and a bitstream of the visual data with a neural network (NN)-based model, statistical information associated with a first representation of the visual data;
determining at least one sample from a second representation of the visual data based on the statistical information, a value of the at least one sample being absent from the bitstream, the second representation being associated with the first representation; and
performing the conversion based on the determining.

2. The method of claim 1, wherein the first representation comprises a latent representation of the visual data or a residual latent presentation of the visual data.

3. The method of claim 1, wherein the first representation is generated based on applying a first neural network in the NN-based model to the visual data, and the second representation is obtained by quantizing the first representation.

4. The method of claim 1, wherein determining the at least one sample from the second representation comprises determining the at least one sample comprises a sample of the second representation in accordance with a determination that at least one of the following conditions is satisfied: a first statistical value corresponding to the sample is smaller than a first threshold, a value determined based on the first statistical value is smaller than a second threshold, or a probability that a value of the sample is equal to a target value is smaller than a third threshold, or
wherein determining the at least one sample from the second representation comprises determining the at least one sample comprises samples in a block of the second representation in accordance with a determination that at least one of the following conditions is satisfied: a first statistical value corresponding to each sample in the block is smaller than a fourth threshold, a first metric is smaller than a fifth threshold, the first metric being determined based on first statistical values corresponding to samples in the block, a probability that a value of each sample in the block is equal to a target value is smaller than a sixth threshold, or a second metric is smaller than a seventh threshold, the second metric being determined based on probabilities that values of samples in the block are equal to respective target values, or
wherein determining the at least one sample from the second representation comprises determining the at least one sample comprises a sample of the second representation in accordance with a determination that at least one of the following conditions is satisfied: a first statistical value corresponding to the sample is larger than an eighth threshold, a value determined based on the first statistical value is larger than a ninth threshold, or a probability that a value of the sample is equal to a target value is larger than a tenth threshold, or
wherein determining the at least one sample from the second representation comprises determining the at least one sample comprises samples in a block of the second representation in accordance with a determination that at least one of the following conditions is satisfied: a first statistical value corresponding to each sample in the block is larger than an eleventh threshold, a first metric is larger than a twelfth threshold, the first metric being determined based on first statistical values corresponding to samples in the block, a probability that a value of each sample in the block is equal to a target value is larger than a thirteenth threshold, or a second metric is larger than a fourteenth threshold, the second metric being determined based on probabilities that values of samples in the block are equal to respective target values.

5. The method of claim 4, wherein the first metric is an average, a minimum one or a maximum one of the first statistical values, or the second metric is an average, a minimum one or a maximum one of the probabilities, or
wherein a size of the block is N by M, and each of N and M is a positive integer, or
wherein the first statistical value is a variance.

6. The method of claim 5, wherein N and M are indicated in the bitstream.

7. The method of claim 4, wherein a target value of a sample comprises one of the following:
a first predetermined value, or
a second statistical value corresponding to the sample.

8. The method of claim 7, wherein the first predetermined value is zero, or the second statistical value is a mean.

9. The method of claim 4, wherein the probability is determined based on the statistical information, or
wherein at least one of the following thresholds is indicated in the bitstream: the first threshold, the second threshold, the third threshold, the fourth threshold, the fifth threshold, the sixth threshold, the seventh threshold, the eighth threshold, the ninth threshold, the tenth threshold, the eleventh threshold, the twelfth threshold, the thirteenth threshold, or the fourteenth threshold.

10. The method of claim 1, wherein performing the conversion comprises:
reconstructing the second representation based on the at least one sample; and
performing the conversion based on the reconstructed second representation.

11. The method of claim 10, wherein the at least one sample comprises all samples of the second representation, and reconstructing the second representation comprises determining values of the at least one sample to reconstruct the second representation, or
wherein the second representation comprises the at least one sample and a first set of samples different from the at least one sample, and reconstructing the second representation comprises: determining values of the at least one sample; obtaining values of the first set of samples by performing entropy decoding process on the bitstream based on the statistical information; and reconstructing the second representation based on the values of the first set of samples and the determined values of the at least one sample.

12. The method of claim 11, wherein determining values of the at least one sample comprises:
determining a value of each sample of the at least one sample to be a second predetermined value or a third statistical value corresponding to the sample.

13. The method of claim 10, wherein the first representation is a latent representation of the visual data, and performing the conversion based on the reconstructed second representation comprises: reconstructing the visual data by performing a synthesis transform on the reconstructed second representation, or
wherein the first representation is a residual latent representation of the visual data, and performing the conversion comprises: generating a quantized latent representation of the visual data based on the reconstructed second representation and a fourth statistical value comprised in the statistical information; and reconstructing the visual data by performing a synthesis transform on the quantized latent representation.

14. The method of claim 13, wherein the fourth statistical value is a mean.

15. The method of claim 1, wherein the statistical information is generated by using a second neural network in the NN-based model, and the second neural network comprises a hyper scale decoder subnetwork for generating a variance.

16. The method of claim 1, wherein at least one of the following is indicated in the bitstream: information on whether to apply the method, or information on how to apply the method, or
wherein at least one of the following is dependent on a color format and/or a color component of the visual data: information on whether to apply the method, or information on how to apply the method, or
wherein a value included in the bitstream is coded at one of the following: a sequence level, a picture level, a slice level, or a block level, or
wherein a value included in the bitstream is binarized before being coded, or
wherein a value included in the bitstream is coded with at least one arithmetic coding context, or
wherein the visual data comprise a picture of a video or an image.

17. The method of claim 1, wherein the conversion includes encoding the visual data into the bitstream, or
wherein the conversion includes decoding the visual data from the bitstream.

18. An apparatus for visual data processing comprising a processor and a non-transitory memory with instructions thereon, wherein the instructions upon execution by the processor, cause the processor to perform acts comprising:
obtaining, for a conversion between visual data and a bitstream of the visual data with a neural network (NN)-based model, statistical information associated with a first representation of the visual data;
determining at least one sample from a second representation of the visual data based on the statistical information, a value of the at least one sample being absent from the bitstream, the second representation being associated with the first representation; and
performing the conversion based on the determining.

19. A non-transitory computer-readable storage medium storing instructions that cause a processor to perform acts comprising:
obtaining, for a conversion between visual data and a bitstream of the visual data with a neural network (NN)-based model, statistical information associated with a first representation of the visual data;
determining at least one sample from a second representation of the visual data based on the statistical information, a value of the at least one sample being absent from the bitstream, the second representation being associated with the first representation; and
performing the conversion based on the determining.

20. A non-transitory computer-readable recording medium storing a bitstream of visual data which is generated by a method performed by an apparatus for visual data processing, wherein the method comprises:
obtaining statistical information associated with a first representation of the visual data;
determining at least one sample from a second representation of the visual data based on the statistical information, a value of the at least one sample being absent from the bitstream, the second representation being associated with the first representation; and
generating the bitstream with a neural network (NN)-based model based on the determining.
